(19) United States
(12) Patent Application Publication
(10) Pub. No.: US 2013/0332377 A1
(43) Pub. Date: Dec. 12, 2013

(54) Apparatus and method for providing and/or for processing information pertaining to and/or relating to principal/agent relationships and/or activities involving agents and third parties

(71) Applicant: Raymond Anthony Joao, Yonkers, NY (US)

(72) Inventor: Raymond Anthony Joao, Yonkers, NY (US)

(21) Appl. No.: 13/987,019

(22) Filed: Jun. 25, 2013

Related U.S. Application Data
(63) Continuation-in-part of application No. 13/986,794, filed on Jun. 5, 2013.
(60) Provisional application No. 61/689,523, filed on Jun. 7, 2012.
(60) Provisional application No. 61/690,514, filed on Jun. 28, 2012.

(51) Int. Cl. G06Q 30/00

(52) U.S. Cl. CPC G06Q 30/018
USPC 705/317

(57) ABSTRACT

A computer-implemented method, including receiving, with a receiver or a computer, a search request for information regarding an agent; processing, with the computer or with a second computer, the search request; generating, with the computer or with a second computer, a message in response to the search request, wherein the message contains information identifying at least one agent in response to the search request; and transmitting, from a transmitter, the first computer, or the second computer, the message to a communication device used by or associated with a user.

### RELATED APPLICATIONS

This application is a continuation-in-part application of U.S. patent Application Ser. No. 13/986,794, filed Jun. 5, 2013, and entitled “APPARATUS AND METHOD FOR PROVIDING AND/OR FOR PROCESSING INFORMATION PERTAINING TO AND/OR RELATING TO PRINCIPAL/AGENT RELATIONSHIPS AND/OR ACTIVITIES INVOLVING AGENTS AND THIRD PARTIES”, the subject matter and teachings of which are hereby incorporated by reference herein in their entirety. U.S. patent application Ser. No. 13/986,794, filed Jun. 5, 2013, claims the benefit of the priority of U.S. Provisional Patent Application Ser. No. 61/689,523, filed Jun. 7, 2012, and entitled “APPARATUS AND METHOD FOR PROVIDING AND/OR FOR PROCESSING INFORMATION PERTAINING TO AND/OR RELATING TO PRINCIPAL/AGENT RELATIONSHIPS AND/OR ACTIVITIES INVOLVING AGENTS AND THIRD PARTIES”, the subject matter and teachings of which are hereby incorporated by reference herein in their entirety. This application also claims the benefit of the priority of U.S. Provisional Patent Application Ser. No. 61/690,514, filed Jun. 28, 2012, and entitled “APPARATUS AND METHOD FOR PROVIDING AND/OR FOR PROCESSING INFORMATION PERTAINING TO AND/OR RELATING TO PRINCIPAL/AGENT RELATIONSHIPS AND/OR ACTIVITIES INVOLVING AGENTS AND THIRD PARTIES”, the subject matter and teachings of which are hereby incorporated by reference herein in their entirety.

### FIELD OF THE INVENTION

The present invention pertains to an apparatus and method for providing and/or for processing information pertaining to and/or relating to principal/agent relationships and/or activities involving agents and third parties and, in particular, to an apparatus and method for providing information regarding principal/agent relationships and/or for providing information regarding any types or kinds of activities, communications, correspondences, attempted transactions, alleged transactions, alleged agreements, completed transactions, completed agreements, binding agreements, non-binding agreements, agreements to agree, alleged agreements to agree, actions by a principal, actions by an agent, and/or actions by a third party, and/or any information regarding a principal, an agent, or a third party, in a public network environment or in a private network environment.

### BACKGROUND OF THE INVENTION

The law of agency is a basic principal in contract law and in business law. A “principal” is one who has authorized, permitted, or directed, another, the so-called “agent”, to act on his or her behalf with another, the so-called “third party”. An agent may be vested with only certain limited authority to act on behalf of a principal. While utilizing an agent can have many advantages, there are many risks involved in using agents. For example, an agent may act outside of the scope of the authority provided to him, her or it, and thereby cause harm to the principal. Also, a dishonest or unscrupulous third party may seek to claim an agreement with an unknowing principal based on discussions or exchanges with an agent. In these instances, the use of an agent can cause great harm to a principal.

In today's day and age, where agents can be found in every walk of life, principals need to be protected from the unauthorized actions of agents and the dishonest acts of third parties. These are a number of shortcoming in the prior art which result in principals not being provided with adequate protection from actions of their agent or agents and from the action of dishonest and unscrupulous third parties.

### SUMMARY OF THE INVENTION

The present invention pertains to an apparatus and method for providing and/or for processing information pertaining to and/or relating to principal/agent relationships and/or activities involving agents and third parties and, in particular, to an apparatus and method for providing information regarding principal/agent relationships and/or for providing information regarding any types or kinds of activities, communications, correspondences, attempted transactions, alleged transactions, alleged agreements, completed transactions, completed agreements, binding agreements, non-binding agreements, agreements to agree, alleged agreements to agree, actions by a principal, actions by an agent, and/or actions by a third party, and/or any information regarding a principal, an agent, or a third party, in a public network environment or in a private network environment.

The present invention pertains to an apparatus and method for providing and/or for processing information pertaining to and/or relating to principal/agent relationships and/or activities involving agents and third parties and, in particular, to an apparatus and method for providing information regarding principal/agent relationships and/or for providing information regarding any types or kinds of activities, communications, correspondences, attempted transactions, alleged transactions, alleged agreements, completed transactions, completed agreements, binding agreements, non-binding agreements, agreements to agree, alleged agreements to agree, actions by a principal, actions by an agent, and/or actions by a third party, and/or any information regarding a principal, an agent, or a third party, in a public network environment or in a private network environment.

The present invention provides a system and/or a platform by which any pertinent information regarding principals, agents, principal/agent relationship(s), or third parties, or any actions or activities of or by agents, third parties, or principals, can be recorded, stored, provided, or otherwise made available, to any interested person, individual or entity, to a principal, an agent, or a third party, for any useful purpose.

The present invention can be utilized on or over, or in conjunction with any communication network or system, the Internet and/or the World Wide Web, and/or by or via a cellular or wireless communications network.

The present invention can be utilized in order to provide information of any kind or type regarding a principal, an agent, a relationship between a principal and an agent, an action(s) of a principal, an action(s) of an agent, information regarding a third party, and/or an action(s) of a third party.

The present invention can be utilized to provide notifications to a principal regarding actions or activities involving his, her, or its, agent. The present invention can also allow a principal to terminate an authority of an agent, to disavow or reject an action of an agent or any person, individual, or individually who attempts to hold himself, herself, or itself out as an agent of the principal, to terminate discussions between an agent, or one holding himself, herself, or itself out as an agent of the principal, and a third party, and to take any action needed or desired to document such action or actions so as to allow the principal to protect himself, herself, or itself, from any unauthorized actions of any agent, anyone holding themselves out as an agent, and any third party.

The present invention can also be utilized to allow a principal to register information regarding an agent including, but not limited to the agent's name, business name, employer, address, telephone number(s), e-mail address, instant message or text message telephone number, the scope and limit of the agent's authority to represent or to act on behalf of the principal, the agent's authority to negotiate deals or contracts for the principal, limitation(s) on the agent's authority to negotiate deals or contracts for the principal, rights reserved by the principal such as, but not limited to, the principal's instructions that the all actions of the agent are subject to the principals written consent or other express consent of the principal or that all actions of the agent are subject to review by the principal and/or that the principal reserves the right to reject or disavow any action(s) of the agent. Agents can also register information regarding a principal including, but not limited to the principal's name, business name, employer, address, telephone number(s), e-mail address, instant message or text message telephone number, the scope and limit of the agent's authority to represent or to act on behalf of the principal, the agent's authority to negotiate deals or contracts for the principal, limitation(s) on the agent's authority to negotiate deals or contracts for the principal, rights reserved by the principal such as, but not limited to, the principals instructions that the all actions of the agent are subject to the principals written consent or other express consent or that all actions of the agent are subject to review and that the principal reserves the right to reject or disavow any action(s) of the agent. Third parties can also register information regarding himself, herself, or itself including, but not limited to the name, business name, employer, address, telephone number(s), e-mail address, and/or instant message or text message telephone number.

The present invention can also be utilized in order to provide a notification message or an alert message to a principal when an agent of the principal begins acting on behalf of the principal or when a person, individual, or entity holds himself, herself, or itself, out as an agent for the principal. The notification message or alert message can be a message sent in real-time or in other than real-time. The present invention can allow a principal to terminate or disavow any action or actions by the agent of one holding them self or itself out as an agent for the principal. The present invention can also be utilized so as to allow a principal to reject, disavow, accept, or confirm, any action taken by an agent or one holding them self or itself out as an agent for the principal, or to terminate a relationship with an agent, and to document and store in an appropriate database, and/or to provide information regarding the rejection, disavowal, acceptance, or confirmation, or the agent termination, to the third party or to the World at large. The present invention can also be utilized in order to record, store, and report to any appropriate individual or entity, or governmental or trade authority, any third party who acts in a dishonest or deceitful manner so as to put others on notice of that third party.

The present invention can also provide an on-line electronic forum in which an agent can correspond with a third party while allowing the principal to monitor, and/or participate in, such correspondence, as well as allowing the principal to terminate such discussions between the agent and third party at any time. All correspondences can be recorded, stored, and archived, for later use to protect the rights of the principal, the agent, and/or the third party, if needed or desired.

The present invention can also be utilized in order to provide a venue for principals to identify, locate, and/or hire agents for their needs or requirements.

The present invention can be utilized in connection with any principal/agent relationship, any relationship involving an individual acting as an attorney for another, and/or any relationship involving an individual acting in a representative capacity for another. The present invention can be utilized in any field in which a principal may utilize an agent, a representative of the principal, or one who is designated to act on behalf of the principal.

The apparatus of the present invention can include a central processing computer or server computer which can provide control over the apparatus and can perform any and/or all of the various processing operations and/or functionality for providing the various services described herein as being provided by the present invention. Any number of central processing computers can be utilized in order to provide the servicing functions described herein as being provided by the present invention.

A given central processing computer may service a field of principal/agent relationships such as, but not limited to, legal or attorney/client relationships, healthcare or doctor/patient relationships, business relationships, entertainment and/or sports representative relationships, such as, but not limited to, sports agents, entertainment agents, commercial agents, personal relationships, individual estate relationships, or any other relationships in any type or kind of field or market.

The apparatus of the present invention can also include an official records computer which can store and maintain, and be a repository for, any and/or all or principal/agent or any other representative capacity relationships serviced by the present invention. The official records computer can also be a repository for the recording of retainer agreements, agent agreements, agency or representative agreements, powers of attorney, retention agreements, employment agreements, consent agreements, agreements formed between users of the present invention or their representatives, registries of principals and their agents, registries of individuals or entities and their designated agents or representative, principals, agents, individuals, representatives, and/or third parties who desire to register to utilized the apparatus and method of the present invention, information regarding terminated agency relationships, terminated representative capacity relationships, complaints regarding agents, complaints regarding principals, complaints regarding third parties, and/or any other information which may be useful, needed, or desired by any user of the apparatus and method of the present invention.

The apparatus can also include any number of user computers or user communication devices which can be used by or which can be associated with any user of the apparatus and method of the present invention. The user communication device can also be, or can include, a personal computer, a home computer, a laptop computer, a handheld computer, a personal communication device, a personal communication services device, a wireless telephone, wireless communication device, a cellular telephone, a personal digital assistant, a “smart” telephone, a mobile telephone, a video telephone, a videophone, a personal communication services device, or a watch, or any other communication device. The user communication device can be used to allow any user to interact with the central processing computer, with the official records computer, and/or with any other user communication device of, associated with, or used by, any other user, person, individual or entity.

The present invention can be utilized, via, on, or over, any one or combination of a telecommunication network(s) or system(s), a satellite communication network(s) or system(s), a radio communication network(s) or system(s), a digital communication network(s) or system(s), a digital satellite communication network(s) or system(s), a personal communications services network(s) or system(s), a cable television network(s) or system(s), satellite or dish television network(s) or system(s), a digital television network(s) or system(s), a broadband communication network(s) or system(s), a low earth orbiting satellite (LEOs) network(s) or system(s), the Internet and/or the World Wide Web, a cellular communication network(s) or system(s), a wireless communication network(s) or system(s), and/or on or over any suitable internet(s) and/or intranet(s).

The present invention can be utilized in many different ways to provide and/or to process information pertaining to and/or relating to a principal/agent relationship and/or any activity or activities involving an agent and a third party. The present invention can also be utilized in many ways in order to provide information regarding a principal/agent relationship and/or to provide information regarding any type or kind of activities, communications, correspondences, attempted transactions, alleged transactions, alleged agreements, completed transactions, completed agreements, binding agreements, non-binding agreements, agreements to agree, alleged agreements to agree, actions by a principal, actions by an agent, and/or actions by a third party, and/or any information regarding a principal, an agent, or a third party.

The present invention can be utilized by a principal to register information regarding an agent of or for the principal. The present invention can also be utilized by an agent to register information regarding a principal of the agent. In this manner, information regarding a principal/agent relationship can be registered with the present invention and can be made available for third parties or any other persons, individuals, or entities, who or which desire to ascertain the existence or to confirm a principal/agent relationship.

The present invention can also be utilized by an agent, or by a third party or any other individual, person, or entity, acting as a principal or as an agent for another, in order to register information regarding his, her, or its agency relationship with his, her, or its, principal. In such a use or embodiment, the agent can access the central processing computer via a user communication device and enter and transmit the name of the agent's firm, company, or employer, contact information, telephone number, e-mail address, text message telephone number, or any other contact information, information regarding the scope of the authority of the agent to act on behalf of the principal, information regarding permitted activities or limitations on activities of the agent, information regarding powers or rights granted to the agent, information regarding powers or rights reserved by the principal, information regarding whether or not the agent can act on behalf of the principal without the principals written or express consent, information regarding whether or not the principal's written or express consent is required before the principal will agree to be bound, information regarding a requirement or a request that the principal, and/or his, her, or its attorney(s) of other representatives be sent a notification message or an alert message, or be notified of and/or before, during, or after, any correspondence, communication, negotiation, or any other activity or activities of the agent on behalf of the principal or any correspondence, communication, negotiation, or any other activity or activities of the agent with any third party or any other person, individual or entity, information regarding whether the principal requires that all correspondence or communication between the agent and a third party be recorded and stored in or by the present invention, and any other information which a principal may desire to post about his, her, or its, agent, and their principal and agent relationship.

The agent can enter and transmit information regarding his, her, or its identity, firm or company name, address and contact information, information regarding the name or identity of his, her, or its, principal, the name of the principal, the name of the principal's firm, company, or employer, information regarding the scope of the authority of the agent to act on behalf of the principal, information regarding permitted activities or limitations on activities of the agent, information regarding powers or rights granted to the agent, information regarding powers or rights reserved by the principal, information regarding whether or not the agent can act on behalf of the principal without the principal's written or express consent, information regarding whether or not the principal's written or express consent is required before the principal will agree to be bound, information regarding requirements that the principal be notified of, before, during, or after, any correspondence, information regarding a request to be notified when a third party, individual, person, or entity, requests information regarding the agent or his, her, or its, principal, information regarding whether the principal requires that all correspondence or communication between the agent and a third party be recorded and stored in or by the present invention, and any other information which an agent may desire to post about his, her, or its, principal, and their principal and agent relationship.

Any third party, individual, person, or entity, may be a principal or an agent for a principal and can register as such with the present invention.

The present invention can also be utilized by any third party, individual, person, entity, or any agent, in order to ascertain information regarding any principal and/or the principal's agent, or any information regarding their principal/agent relationship.

The respective third party, individual, person, entity, or agent, can utilize the present invention in order to determine information regarding any principal or agent registered with same. For example, the present invention can be utilized to allow any third party, individual, person, entity, or agent, to determine or ascertain the identify of an agent of a principal, obtain agent contact information, telephone number, e-mail address, text message telephone number, or any other contact information, information regarding the scope of the authority of the agent to act on behalf of the principal, determine or ascertain information regarding permitted activities or limitations on activities of the agent, determine or ascertain information regarding powers or rights granted to the agent, determine or ascertain information regarding powers or rights reserved by the principal, determine or ascertain information regarding whether or not the agent can act on behalf of the principal without the principal's written or express consent, determine or ascertain information regarding whether or not the principal's written or express consent is required before the principal will agree to be bound, determine or ascertain information regarding a requirement or a request that the principal, and/or his, her, or its attorney(s) of other representatives be sent a notification message or an alert message, or be notified of and/or before, during, or after, any correspondence, communication, negotiation, or any other activity or activities of the agent on behalf of the principal or any correspondence, communication, negotiation, or any other activity or activities of the agent with any third party or any other person, individual or entity, determine or ascertain information regarding whether the principal requires that all correspondence or communication between the agent and a third party be recorded and stored in the apparatus 100, or determine or ascertain and any other information regarding the principal or the agent for the principal.

The present invention can also be utilized to provide a notification message or an alert message to a principal or an agent when information is requested by the respective third party, individual, person, or entity about the principal or the agent. The notification message or alert message can contain information regarding the identity of the requesting third party, individual, person, or entity, the information contained in the request for information, and/or the information contained in the message sent to the requesting third party, individual, person, or entity. In this regard, the present invention can provide a principal or the principal's agent with a notification that a respective third party, individual, person, or entity, has inquired about them, and what information was sought by that respective third party, individual, person, or entity.

The present invention can also be utilized to allow a third party may locate and identify an agent for a principal and can utilize the present invention in order to make contact with, correspond with, negotiate with, and enter into agreements or contracts, with the agent and/or the principal via the agent. The present invention can also a notification message or an alert message to notify or inform the principal, such as by e-mail message, instant message, text message, automated telephone message to a telephone, a landline telephone, a cellular or wireless telephone, or any other communication device or user communication device.

The present invention can also be utilized to provide an electronic, virtual, on-line, or web-based, forum, or a chat room, or other forum, in which or via which an agent of a principal, the principal himself, herself, or itself, and the third party, can engage in discussions, communications, correspondences, negotiations, and/or any other activities, in order to conduct business, negotiate a contract, negotiate an agreement, enter into an agreement or a contract, negotiate a settlement in the case where a dispute or a lawsuit exists or is pending between the principal and a party represented by the third party, compromise a dispute or lawsuit, settle a dispute or lawsuit, or otherwise reach an agreement, accord, or settlement, to put an end to a dispute or a pending lawsuit between the principal and a party represented by the third party.

A respective principal, agent, and third party, can agree to conducting their discussions, communications, correspondences, negotiations, and/or any other activities, via the electronic, virtual, on-line, or web-based, forum, or a chat room, or other forum, and can agree to any terms and conditions either dictated by same or otherwise agreed to by the parties.

The respective electronic, virtual, on-line, or web-based, forum, or a chat room, or other forum, can include, record, and store, any and all text or written correspondence or communications, recordings of any and all off-line telephone conversations or conference calls, or recordings of any video conference calls, between the parties, any and all draft agreements exchanges between the parties, and any other information communicated or exchanged between the parties so as to provide a complete and comprehensive record of all discussions, communications, correspondences, negotiations, and/or any other activities. Audio recordings, video recordings, pictures, photographs, and any other audio or video information evidencing all discussions, communications, correspondences, negotiations, and/or any other activities can also be recorded and stored. In this manner, a complete record of any and all discussions, communications, correspondences, negotiations, and/or any other activities, between the parties can be recorded and stored.

The parties can agree beforehand that any and all discussions, communications, correspondences, negotiations, and/or any other activities, relied upon by the parties must be recorded and stored using the present invention. Such an agreement can serve to prevent later disputes regarding what has transpired in the respective discussions, communications, correspondences, negotiations, and/or any other activities.

The parties, including the agent, the principal, and the third party, can be provided with information for accessing a secure electronic forum, virtual meeting room, or chat room, or other virtual or other forum. The parties, including the agent, the principal, and the third party, can be provided with information for accessing a secure and recorded conference call forum or a recorded video conference call forum.

The secure electronic forum, virtual meeting room, or chat room, or other virtual or other forum (hereinafter “the electronic forum”) can also display prominently any messages, terms, or conditions, of any and all discussions, communications, correspondences, negotiations, and/or any other activities, such as, but not limited to, “Theses discussions are not binding on the Principal without the Principal's express written consent”, “The agent is not authorized to bind the Principal”, “The Agent is authorized to bind the Principal”, “The Third Party is not authorized to bind their Principal.”, “The Third Party is authorized to bind their Principal”, “All discussions are Confidential or subject to F.R.E. 408 or more stringent confidentiality.”, minimum requirements for agreement or settlement, or any other information which either the principal, the agent, or the third party, or the third party's principal, wants or requires to be posted. Electronic forum meetings can be scheduled by the agent, the third party, the principal of the agent, and/or the principal of the third party.

The present invention can also generate and transmit to any one or more of the agent, the third party, the principal of the agent, or the principal of the third party, an electronic meeting notification message which can be transmitted to respective user communication device of the respective agent, the third party, the principal of the agent, or the principal of the third party.

Once the electronic forum meeting has commenced, any and all discussions, communications, correspondences, negotiations, and/or any other activities can occur in the electronic forum until the parties or participants decide to end a session or to end the discussions, communications, correspondences, negotiations, and/or any other activities. The present invention can record and store any and all discussions, communications, correspondences, negotiations, and/or any other activities, any exchanged documents, and any recorded telephone calls or video conference calls.

The recorded and stored discussions, communications, correspondences, negotiations, and/or any other activities, any exchanged documents, and any recorded telephone calls or video conference calls, can be retrieved at any time to provide a record, and evidence if need be, of any and all discussions, communications, correspondences, negotiations, and/or any other activities, any exchanged documents, and any recorded telephone calls or video conference calls, exchanged by the parties or participated in by the parties.

The principal can, at any time, access the present invention, and can terminate discussions, communications, correspondences, negotiations, and/or any other activities, between the parties, can terminate an agent, can disavow an agent's actions, can agree to an agent's actions, can supersede an agent's actions, or can accept or reject an offer or an agreement. The present invention can generate a message containing information regarding the principal's action(s) and can transmit the message to a respective user communication device of each of the agent and the third party.

Any party to the electronic forum discussions, communications, correspondences, negotiations, and/or any other activities, any exchanged documents, and any recorded telephone calls or video conference calls, or any agent, attorney, or representative of same, can access the present invention or the central processing computer of same and can request and retrieve any and/or all of the discussions, communications, correspondences, negotiations, and/or any other activities, any exchanged documents, and any recorded telephone calls or video conference calls, which took place in the electronic forum between the parties.

The present invention can also allow the principal of the agent may access and/or monitor the discussions, communications, correspondences, negotiations, and/or any other activities, any exchanged documents, and any recorded telephone calls or video conference calls, in the electronic forum at any time. The present invention can also allow any other agent, attorney, or representative, of the principal may access and/or monitor the discussions, communications, correspondences, negotiations, and/or any other activities, any exchanged documents, and any recorded telephone calls or video conference calls, in the electronic forum at any time.

The present invention can also be utilized in order to store any and/or all agreements or contracts entered into by any of the parties who or which utilize the present invention, whether these agreements or contracts are confidential or not. These agreements or contracts can also be stored and maintained confidentially and/or for any purpose, for evidentiary purposes, or for later retrieval and use by a party. These agreements or contracts can also be made available and provided to any other user of the present invention if appropriate permission is obtained from the parties.

Blank forms or template agreements or contracts can also be stored and can be provided or can be sold to any other users of the present invention. In this manner, the present invention can be utilized as a repository for agreements and/or contracts between parties, for later use by the parties, and/or can be a source of blank or template agreements or contracts which the parties or other users of the present invention can obtain and utilize in their dealings with others.

The present invention can be utilized by agents, representatives, attorneys, or any other individuals, persons, or entities, who or which act on behalf of any principal, client, customer, or any other individual, person or entity. For example, the present invention can, be utilized by agents, attorneys, or representatives, for legal clients, celebrities, actors, actresses, television personalities, athletes, sports professionals, amateur athletes, high school and college athletes, performers, or individuals or entities in any walk of life, or any other individual, person, or entity, that may have for a need for, or a desire to utilize or employ the services of, an agent, an attorney, a representative, or a personal representative, in any type or kind of field, industry, activity, action, or in any endeavor.

The present invention can also be utilized to receive, store, and provide upon request, information regarding references, compliments, complimentary statements, positive reviews, negative reviews, or complaints, about or regarding any of the principals, agents, third parties, or any other individuals, persons, or entities, who or which utilize the present invention or who or which engage in activities which involve use of the present invention. In this regard, the present invention can be utilized to perform research regarding any of the herein-described principals, agents, third parties, or any other individuals, persons, or entities. In this regard, the present invention can be utilized in order to process requests for, and to generate and transmit or otherwise provide messages regarding, any information regarding references, compliments, complimentary statements, positive reviews, negative reviews, or complaints, about or regarding any of the herein-described agents, third parties, or any other individuals, persons, or entities.

The present invention can transcribe any audio from any of the herein-described telephone calls or video conference calls into text information which can be stored in connection with any of the herein-described electronic forum discussions, communications, correspondences, negotiations, and/or any other activities. The apparatus of the present invention, or any components of same, can be equipped or provided with audio to text transcription software and/or hardware.

The present invention can also translate any text information from one language into another language and came store any such translations. The apparatus of the present invention, or any components of same, can also be equipped or provided with any language translation software and/or hardware for performing language translation from one language into any number of languages.

The present invention can also generate a notification message or an alert message whenever a third party inquires about, communicates with, or corresponds with, an agent or seeks to obtain information regarding the principal or the principals agent and can transmit same to a user communication device of the principal or to a user communication device of the agent or to an e-mail server of a respective principal or agent in order to provide notification to, or to inform.

The present invention can also be utilized to provide a forum or venue in which, or a communication forum or private forum, in which a principal can communicate instructions, directives, or other information, to an agent as well as to allow an agent to communicate information or suggestions, or an offer, to a principal. The respective communication, instruction(s), directive(s), suggestion(s), or information, can be entered into a user communication device which can be used by a respective principal or agent, and can be transmitted in a message which can be sent from the user communication device to the central processing computer. The central processing computer can receive and process the message, can identify the sender of the message as a principal or an agent, can determine the agent for the principal or the principal of the agent (“the identified agent” or “the identified principal”, respectively), and can transmit the message to the user communication device, or to an e-mail server of, for, or associated with, the identified agent or the identified principal. In this manner, the present invention can be used to provide or facilitate a forum or venue in which a principal and his, her, or its, agent can communicate.

Any and/or all of the herein-described messages can be recorded, stored, and/or archived in the central processing computer and any of the herein-described messages can be maintained as “Confidential”. Any and/or all of the herein-described messages can also be stored in the official records computer. Any and/or all of the herein-described messages can also be stored in and/or downloaded to and/or stored in a user communication device of a respective user, principal, or agent.

The present invention can also be utilized in order to allow a principal, client, customer, or any individual or entity (hereinafter “principal” or “prospective principal”), to search for, identify, or locate, an agent, an attorney, or a representative. In a preferred embodiment, an agent, attorney, or representative, can post information regarding himself, herself, or itself, which information can include, but is not limited to, any of the data or information described herein as being stored in the present invention for, regarding, or relating to, the agent, attorney, or representative.

The principal or prospective principal can access the central processing computer using a user communication device, can enter search criteria regarding a desired type or kind of agent, attorney, or representative, and can transmit a search request to the central processing computer. The central processing computer can receive and process the search request. The central processing computer can identify an agent, attorney, or representative, or any number of agents, attorneys, or representatives, and can generate a search results message which can contain information regarding any identified agent(s), attorney(s) or representative(s). The central processing computer can transmit the search results message to the user communication device.

The search results message can also contain any information, or a link or links to such information, for each identified agent, attorney, or representative. The information can be or can include, but is not limited to, any of the information described herein as being stored in the present invention for, regarding, or relating to, the agent, attorney, or representative. The principal or prospective principal can review the information in the search results message and/or any information regarding any identified agent, attorney, or representative, and decide whether or not to hire, engage, or retain the services of, an identified agent, attorney, or representative. Thereafter, the principal or prospective principal can contact the agent, attorney, or representative.

The principal or prospective principal can also hire, engage, or retain the services or, the agent, attorney, or representative via the present invention. The present invention can also register the agent, attorney, or representative as being the respective agent, attorney, or representative, of the principal or prospective principal, so that that information is available via the present invention to the World at large. Information regarding the agent's, attorney's, or representative's authorization to act on behalf of the principal in any number of situations and any other information can also be stored and provided by the present invention.

The present invention can be utilized in order to allow any principal or prospective principal, or any client, customer, or other individual, to search for and/or hire an agent, attorney, or representative. In the same manner, the present invention can be utilized to allow an agent, attorney, or representative, to promote or advertise himself, herself, or itself, so as become hire, engaged, or retained by principals, clients, or customers, or to otherwise engage in business or client development activities.

The present invention can be utilized, for example, by a high school athlete or an aspiring actor, or any other individual, professional or otherwise in order to find and retain an agent. In a same manner, the present invention can be utilized by any individual or entity to find, hire, engage, or retain, the services of an agent, attorney or representative.

The present invention can also be utilized in order to generate and transmit alert messages to principals or prospective principals when a new agent, attorney, or representative, which meets or might meet the search criteria set by the principal or prospective principal, registers with the present invention.

The present invention can also be utilized in order to allow an agent, attorney, or representative, (hereinafter “agent”), to search for, identify, or locate, a principal, prospective principal, client or customer (hereinafter “principal”). A principal or individual desiring to hire an agent, can post information regarding himself, herself, or itself, which information can include, but is not limited to, any of the data or information described herein as being stored in the present invention for, regarding, or relating to, the principal.

The agent can access the central processing computer using a user communication device, can enter search criteria regarding a desired type or kind of principal or prospective principal, and can transmit a search request to the central processing computer. The central processing computer can receive and process the search request. The central processing computer can identify a principal or prospective principal or any number of principals or prospective principals, and can generate a search results message which can contain information regarding any identified principal(s) or prospective principal(s). The central processing computer can transmit the search results message to the user communication device.

The search results message can also contain any information, or a link or links to such information, for each identified principal or prospective principal. The information can be or can include, but is not limited to, any of the information described herein as being stored in the present invention for, regarding, or relating to, the principal or prospective principal. The agent can review the information in the search results message and/or any information regarding any identified principal or prospective principal and decide whether or not to contact the principal or prospective principal in order to attempt to he hired by, engage by, or retained by the principal or prospective principal. The agent can thereafter contact the principal or prospective principal. The principal or the prospective principal can also hire, engage, or retain the services of, the agent via the present invention. If the principal or prospective principal hires, engages, or retains, the agent, then information regarding same can be registered by the present invention so as to be available via the present invention to the World at large. Information regarding the agent's authorization to act on behalf of the principal in any number of situations and any other information can also be stored and provided by the present invention.

In this regard, the present invention can be utilized in order to allow any agent, attorney, or representative, to search for a principal or prospective principal. In the same manner, the present invention can be utilized to allow an agent, attorney, or representative, to seek to become hired by, engaged by, or retained by, principals, clients, or customers, or to otherwise engage in business or client development activities.

The present invention can be utilized, for example, by a sports or entertainment agent in order to find and secure clients. In a same manner, the present invention can be utilized by any agent, attorney, or representative to find and be hired, engaged, or retained, by any principal, client, or customer.

The present invention can also be utilized in order to generate and transmit alert messages to agents, attorneys, or representatives, when a principal or prospective principal, who or which meets or might meet the search criteria set by the agent, attorney, or representative, registers with the present invention.

The present invention can also be utilized in connection with one or more social networking websites or social networking computer systems such as Facebook®, Twitter, or other social networking computer system or any other social networking computer systems.

The social networking computer system can include all information which can be posted to or stored in or on a social networking computer system or in or on an individual's or an entity's social networking account or page, such as in an individual's or entity's Facebook®, Twitter, or other social networking website account or page. The information stored in the social networking computer system can include, for each individual or entity, identification information, information regarding friends or followers of the individual or entity, or others, professional information, work samples, life history information, personalized statements, video recordings, audio recordings, videos of activities, events, or performances, and any other information which can be store or posted to any social networking website or social networking account for or on behalf of an individual or entity.

Information provided about an agent, attorney, or representative, can contain or include, for each agent, attorney, or representative, a link to information found at the respective agent's, attorney's, or representative's Facebook, Twitter, or other social networking account or page and/or any information stored or posted on or at same. In this regard, the respective principal or prospective principal can be linked to and access information posted or stored on the agent's, attorney's, or representative's, Facebook, Twitter, or other social networking account or page.

Information provided about an individual or entity can contain or include, for each individual or entity, a link to information found at the respective agent's, attorney's, or representative's Facebook, Twitter, or other social networking account or page and/or any information stored or posted on or at same. In this regard, the respective agent, attorney, or representative, can be linked to and access information posted or stored on the agent's, attorney's, or representative's, Facebook, Twitter, or other social networking account or page.

The present invention can be used by any individual or entity, in any field of endeavor, in any walk of life, professional, amateur or otherwise, to promote themselves to agents, attorneys, or representatives, in the hopes of being able to secure the services of or representation by an agent, attorney, or representative in the field of their endeavor. In this manner, as and for an example, an athlete or an aspiring entertainer can post video clips of their performances on their social networking page along with statistics, performance measure, ratings, reviews, or other information, in an ongoing manner so that an agent or agents can monitor or follow them or their progress. In this manner, an agent may scout or follow prospective new clients while the individual or entity can market themselves to agents, attorneys, or representatives.

In an analogous manner, the present invention can be used by any agent, attorney, or representative, in any field of endeavor, in any walk of life, professional, amateur or otherwise, to promote themselves to individuals and entities in the hopes of being hired, engaged, or retained, by an individual or entity. In this manner, as and for an example, a sports or entertainment agent can provide or post information regarding clients, reviews, past successful deals, contact and networking information, video clips, statistics, performance measures, ratings, reviews, or other information, in an ongoing manner so that an individual or entity can monitor or follow them or their progress. In this manner, an individual or agent can scout or follow an agent or his or her progress while the agent can market themselves to individuals and entities.

The present invention can be utilized to store, and serve as a repository for, any and/or all of the information described herein as well as any and all negotiations and/or contracts or agreements which are entered into between any parties who utilize the present invention. The present invention can store any and all communications, correspondence, telephone call recordings, telephone call transcripts, video conferences, video conference transcripts, e-mails, text or SMS messages, or any other information, correspondence, or communications, which occur between and among principals and their agents, agents and third parties, and principals and third parties.

The present invention can also be utilized as a repository for all engagement agreements, employment agreements, independent contractor agreements, retainer agreements, powers of attorney, letters of administration, letters of authorization, proxies, or and any other documents or things that can evidence a principal/agent relationship. In this regard, any engagement agreement, employment agreement, independent contractor agreement, retainer agreement, power of attorney, letter of administration, letter of authorization, proxy, or and any other document or thing that can evidence a principal/agent relationship can be stored in the present invention and can be access and retrieved by any authorized individual at any time.

### BRIEF DESCRIPTION OF THE DRAWINGS

In the Drawings:

FIG. 1 illustrates the apparatus of the present invention, in block diagram form;

FIG. 2 illustrates the central processing computer of the apparatus of FIG. 1, in block diagram form;

FIG. 3 illustrates the official records computer of FIG. 1, in block diagram form;

FIG. 4 illustrates a preferred embodiment of the user computer of FIG. 1, in block diagram form;

FIG. 5 illustrates a preferred embodiment operation of the apparatus of FIG. 1, in flow diagram form;

FIG. 6 illustrates another preferred embodiment operation of the apparatus of FIG. 1, in flow diagram form;

FIG. 7 illustrates still another preferred embodiment operation of the apparatus of FIG. 1, in flow diagram form;

FIG. 8 illustrates yet another preferred embodiment operation of the apparatus of FIG. 1, in flow diagram form;

FIG. 9 illustrates another preferred embodiment operation of the apparatus of FIG. 1, in flow diagram form;

FIG. 10 illustrates still another preferred embodiment operation of the apparatus of FIG. 1, in flow diagram form;

FIG. 11 illustrates yet another preferred embodiment operation of the apparatus of FIG. 1, in flow diagram form; and

FIG. 12 illustrates another preferred embodiment of the apparatus of the present invention, in block diagram form.

### DESCRIPTION OF THE PREFERRED EMBODIMENTS

The present invention pertains to an apparatus and method for providing and/or for processing information pertaining to and/or relating to principal/agent relationships and/or activities involving agents and third parties and, in particular, to an apparatus and method for providing information regarding principal/agent relationships and/or for providing information regarding any types or kinds of activities, communications, correspondences, attempted transactions, alleged transactions, alleged agreements, completed transactions, completed agreements, binding agreements, non-binding agreements, agreements to agree, alleged agreements to agree, actions by a principal, actions by an agent, and/or actions by a third party, and/or any information regarding a principal, an agent, or a third party, in a public network environment or in a private network environment.

The apparatus and method of the present invention, in a preferred embodiment, provides a system and/or a platform by which any pertinent information regarding principals, agents, principal/agent relationship(s), or third parties, or any actions or activities of or by agents, third parties, or principals, can be recorded, stored, provided, or otherwise made available, to any interested person, individual or entity, to a principal, an agent, or a third party, for any useful purpose.

The apparatus and method of the present invention, in a preferred embodiment, can be utilized on or over, or in conjunction with any communication network or system, the Internet and/or the World Wide Web, and/or by or via a cellular or wireless communications network.

In a preferred embodiment, the apparatus and method of the present invention can be utilized in order to provide information of any kind or type regarding a principal, an agent, a relationship between a principal and an agent, an action(s) of a principal, an action(s) of an agent, information regarding a third party, and/or an action(s) of a third party.

The apparatus and method of the present invention can be utilized to provide notifications to a principal regarding actions or activities involving his, her, or its, agent. The apparatus and method of the present invention can also allow a principal to terminate an authority of an agent, to disavow or reject an action of an agent or any person, individual, or individually who attempts to hold himself, herself, or itself out as an agent of the principal, to terminate discussions between an agent, or one holding himself, herself, or itself out as an agent of the principal, and a third party, and to take any action needed or desired to document such action or actions so as to allow the principal to protect himself, herself, or itself, from any unauthorized actions of any agent, anyone holding themselves out as an agent, and any third party.

The apparatus and method of the present invention can also be utilized to allow a principal to register information regarding an agent including, but not limited to the agent's name, business name, employer, address, telephone number(s), e-mail address, instant message or text message telephone number, the scope and limit of the agent's authority to represent or to act on behalf of the principal, the agent's authority to negotiate deals or contracts for the principal, limitation(s) on the agent's authority to negotiate deals or contracts for the principal, rights reserved by the principal such as, but not limited to, the principal's instructions that all actions of the agent are subject to the principal's written consent or other express consent or that all actions of the agent are subject to review by the principal and that the principal reserves the right to reject or disavow any action(s) of the agent. Agents can also register information regarding a principal including, but not limited to the principal's name, business name, employer, address, telephone number(s), e-mail address, instant message or text message telephone number, the scope and limit of the agent's authority to represent or to act on behalf of the principal, the agent's authority to negotiate deals or contracts for the principal, limitation(s) on the agent's authority to negotiate deals or contracts for the principal, rights reserved by the principal such as, but not limited to, the principals instructions that the all actions of the agent are subject to the principals written consent or other express consent or that all actions of the agent are subject to review and that the principal reserves the right to reject or disavow any action(s) of the agent. Third parties can also register information regarding himself, herself, or itself including, but not limited to the name, business name, employer, address, telephone number(s), e-mail address, and/or instant message or text message telephone number.

The apparatus and method of the present invention can also be utilized in order to provide a notification message or an alert message to a principal when an agent of the principal begins acting on behalf of the principal or when a person, individual, or entity holds himself, herself, or itself, out as an agent for the principal. The notification message or alert message can be a message sent in real-time or in other than real-time. The apparatus and method of the present invention can allow a principal to terminate or disavow any action or actions by the agent of one holding them self or itself out as an agent for the principal. The apparatus and method of the present invention can also be utilized so as to allow a principal to reject, disavow, accept, or confirm, any action taken by an agent or one holding them self or itself out as an agent for the principal, or to terminate a relationship with an agent, and to document and store in an appropriate database, and/or to provide information regarding the rejection, disavowal, acceptance, or confirmation, or the agent termination, to the third party or to the World at large. The apparatus and method of the present invention can also be utilized in order to record, store, and report to any appropriate individual or entity, or governmental or trade authority, any third party who acts in a dishonest or deceitful manner so as to put others on notice of that third party.

The apparatus and method of the present invention can also provide an on-line electronic forum in which an agent can correspond with a third party while allowing the principal to monitor, and/or participate in, such correspondence, as well as allowing the principal to terminate such discussions between the agent and third party at any time. All correspondences can be recorded, stored, and archived, for later use to protect the rights of the principal, the agent, and/or the third party, if needed or desired.

The apparatus and method the present invention can also be utilized in order to provide a venue for principals to identify, locate, and/or hire agents for their needs or requirements.

The apparatus and method of the present invention can be utilized in connection with any principal/agent relationship, any relationship involving an individual acting as an attorney for another, and/or any relationship involving an individual acting in a representative capacity for another. The apparatus and method of the present invention can be utilized in any field in which a principal may utilize an agent, a representative of the principal, or one who is designated to act on behalf of the principal.

Applicant hereby incorporates by reference herein the subject matter and teachings of U.S. Provisional Patent Application Ser. No. 61/690,514, filed Jun. 28, 2012, and entitled “APPARATUS AND METHOD FOR PROVIDING AND/OR FOR PROCESSING INFORMATION PERTAINING TO AND/OR RELATING TO PRINCIPAL/AGENT RELATIONSHIPS AND/OR ACTIVITIES INVOLVING AGENTS AND THIRD PARTIES”, the subject matter and teachings of which are hereby incorporated by reference herein in their entirety.

Applicant also hereby incorporates by reference herein the subject matter and teachings of U.S. Provisional Patent Application Ser. No. 61/689,523, filed Jun. 7, 2012, and entitled “APPARATUS AND METHOD FOR PROVIDING AND/OR FOR PROCESSING INFORMATION PERTAINING TO AND/OR RELATING TO PRINCIPAL/AGENT RELATIONSHIPS AND/OR ACTIVITIES INVOLVING AGENTS AND THIRD PARTIES”, the subject matter and teachings of which are hereby incorporated by reference herein in their entirety.

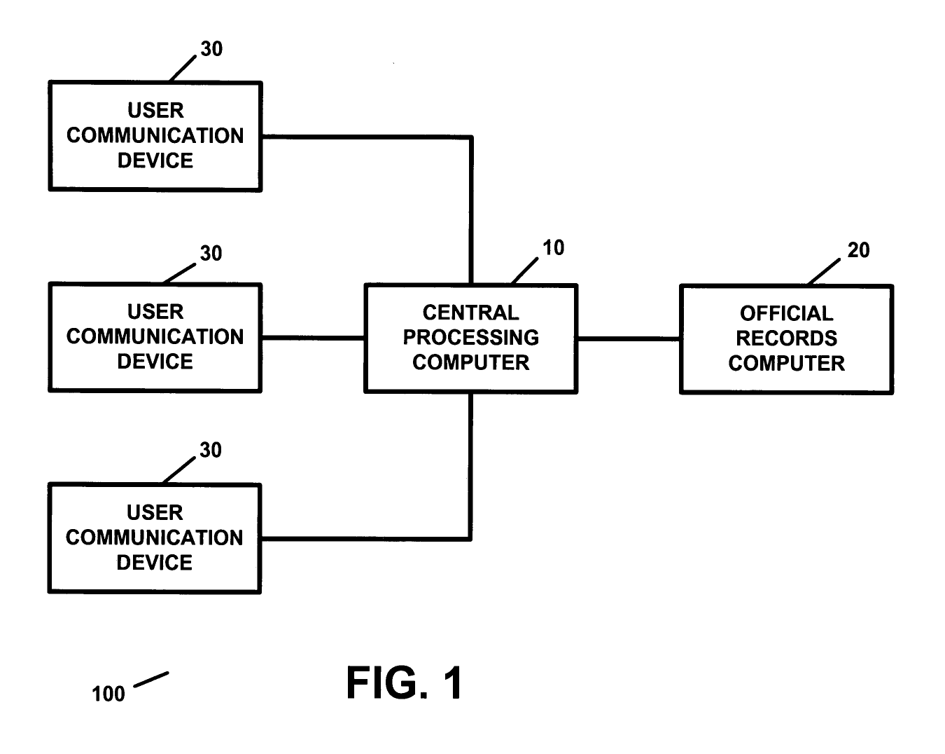

FIG. 1 illustrates a preferred embodiment of the apparatus of the present invention, which is designated generally by the reference numeral 100, in block diagram form. With reference to FIG. 1, the apparatus 100 includes a central processing computer or server computer 10 (hereinafter “central processing computer 10”). The central processing computer 10 provides control over the apparatus 100 and can perform any and/or all of the various processing operations and/or functionality for providing the various services described herein as being provided by the apparatus 100. The central processing computer 10, in the preferred embodiment, can be any suitable computer, network computer, or computer system, and the central processing computer 10 can be comprised of one or more computers or computer systems.

In a preferred embodiment, the central processing computer 10 can have a website associated with same so as to enable use of the apparatus 100 and/or the central processing computer 10 on, over, or via, the Internet and/or the World Wide Web.

In a preferred embodiment, any number of central processing computers 10 can be utilized in order to provide the servicing functions described herein as being provided by the apparatus 100 of the present invention. The central processing computer(s) 10 may be linked to other central processing computers or may be stand alone computers or systems.

A given central processing computer 10 may service a field of principal/agent relationships such as, but not limited to, legal or attorney/client relationships, healthcare or doctor/patient relationships, business relationships, entertainment and/or sports representative relationships, such as, but not limited to, sports agents, entertainment agents, commercial agents, personal relationships, individual estate relationships, or any other relationships in any type or kind of field or market.

With reference once again to FIG. 1, the apparatus 100 also includes official records computer 20 which can be any computer or group of computers which can be connected to or with the central processing computer 10. The official records computer can store and maintain, and be a repository for any and/or all or principal/agent or any other representative capacity relationships serviced by the apparatus 100 and method of the present invention. The official records computer 20 can also be a repository for the recording of retainer agreements, agent agreements, agency or representative agreements, powers of attorney, retention agreements, employment agreements, consent agreements, agreements formed between users of the apparatus 100 or their representatives, registries of principals and their agents, registries of individuals or entities and their designated agents or representative, principals, agents, individuals, representatives, and/or third parties who desire to register to utilized the apparatus 100 and method of the present invention, information regarding terminated agency relationships, terminated representative capacity relationships, complaints regarding agents, complaints regarding principals, complaints regarding third parties, and/or any other information which may be useful, needed, or desired by any user of the apparatus 100 and method of the present invention.

In a preferred embodiment, the official records computer 20 can have a website associated with same so as to enable use of the apparatus 100 and/or the official records computer 20 on, over, or via, the Internet and/or the World Wide Web.

With reference once again to FIG. 1, the apparatus 100 also includes any number of user computers or communication devices 30 (hereinafter “user communication device 30”) which can be used by or which can be associated with any user of the apparatus 100. The term “user” as used herein is defined herein to include, but not be limited to, any principal, agent, attorney, representative, third party, or any individual, person, or entity, which utilized the apparatus 100 and method of the present invention. Any number of user communication devices 30 can be utilized in connection or in conjunction with the apparatus 100 and method of the present invention. In the preferred embodiment, the user communication device 30 can also be, or can include, a personal computer, a home computer, a laptop computer, a handheld computer, a personal communication device, a personal communication services device, a wireless telephone, wireless communication device, a cellular telephone, a personal digital assistant, a “smart” telephone, a mobile telephone, a video telephone, a videophone, a personal communication services device, or a watch, or any other communication device. The user communication device 30 can be used to allow any user to interact with the central processing computer 10, with the official records computer 20, and/or with any other user communication device 30 of, associated with, or used by, any other user, person, individual or entity.

The user communication device 30 can send signals, data, and/or information, to, and/or can receive signals, data, and/or information, from, any one or more of the central processing computer 10, the official records computer 20, and/or any other user communication device 20.

The communications network(s) and/or system(s) via, on, or over, which the apparatus 100 of the present invention can be utilized, and via, on, or over, which any of the herein-described devices 10, 20, and/or 30, may communicate with each other, can include any one or combination of a telecommunication network(s) or system(s), a satellite communication network(s) or system(s), a radio communication network(s) or system(s), a digital communication network(s) or system(s), a digital satellite communication network(s) or system(s), a personal communications services network(s) or system(s), a cable television network(s) or system(s), satellite or dish television network(s) or system(s), a digital television network(s) or system(s), a broadband communication network(s) or system(s), a low earth orbiting satellite (LEOs) network(s) or system(s), the Internet and/or the World Wide Web, a cellular communication network(s) or system(s), a wireless communication network(s) or system(s), and/or on or over any suitable internet(s) and/or intranet(s).

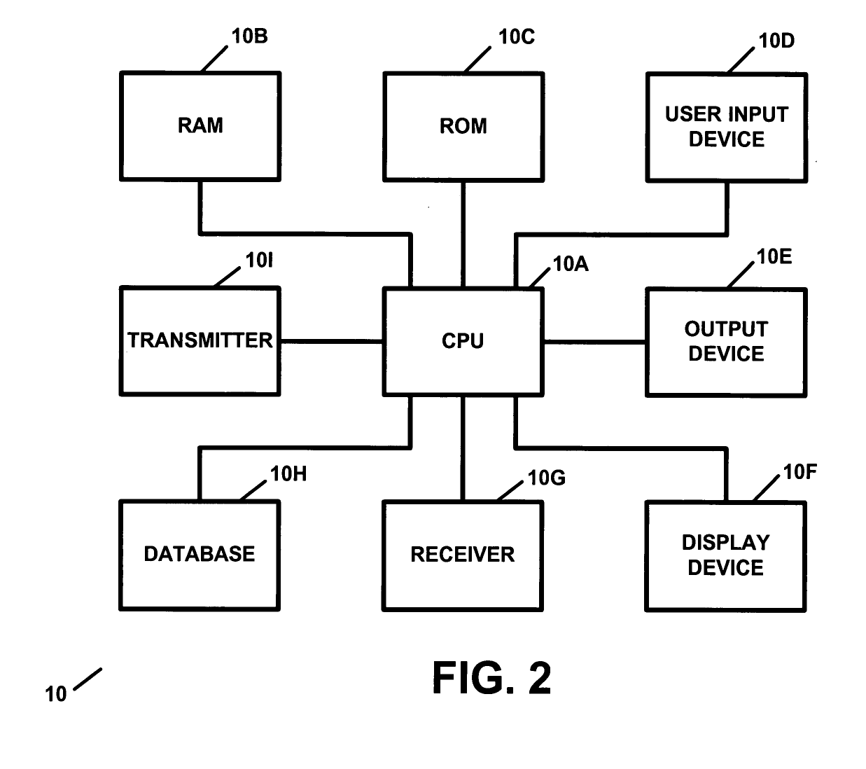

FIG. 2 illustrates the central processing computer 10 of FIG. 1, in block diagram form. The central processing computer 10, in the preferred embodiment, is a network computer or computer system and can consist of, or can include, a single computer or computer system or a plurality of computers or computer systems.

With reference to FIG. 2, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) (RAM) 10B and a read only memory device(s) (ROM) 10C, each of which is connected to the CPU 10A, a user input device 10D which is connected to the CPU 10A, for entering data and/or commands into the central processing computer 10, and which can include any one or more of a keyboard, a scanner, a user pointing device, such as, for example, a mouse, a touch pad, and/or an audio input device and/or a video input device, etc., if desired. The input device(s) is also connected to the CPU 10A. The central processing computer 10 also includes an output device 10E such as a printer, a modem, a fax/modem, or other output device, which is connected to the CPU 10A, and which provides data and/or information to the operator or user of the central processing computer 10 or to any other entity. The central processing computer 10 also includes a display device 10F, which is connected to the CPU 10A, which displays data and/or information to a user or operator.

The central processing computer 10 also includes a receiver 10G, which is also connected to the CPU 10A, and which can include one receiver or any number of receivers, for receiving signals and/or data and/or information from any one or more of any other central processing computer(s) 10, the official records computer 20, and/or any number of user communication devices 30.

The central processing computer 10 also includes a database 10H which can store any and/or all data and/or information needed or required for performing any and/or all of the operations and functions described herein as being performed by or provided by the apparatus 100 and method the present invention. The database 10H can contain any data or information regarding any of the users, principals, agents, or third parties who or which may utilize the apparatus 100 of the present invention and/or any other persons, individuals, or entities, which data or information can include, but is not limited to, name, address, contact information, e-mail address(es), telephone number(s), and/or any other information needed or desired regarding a respective user, principal, agents, and/or third party.

The database 10H can also include, for each principal who or which utilizes the apparatus 100, the principal's name, address, contact information, e-mail address(es), telephone number(s), agent(s), information regarding the authority or powers, or the scope or limits of same, which are granted to the agent, information regarding whether the principal's written consent is needed to bind the principal, information regarding retainer agreements, retention agreements, employment agreements, agent or agency agreements, between the principal and the agent, historical information regarding past actions or activities of the agent on behalf of the principal, information regarding actions of the principal in response to the agents actions, such as whether the principal accepted, confirmed, rejected, or disavowed, the agents actions or activities, information regarding deals entered into between the principal, the agent, and a third party, information regarding third parties with whom the agent or principal have dealt with or corresponded with, information regarding contracts entered into, information regarding contracts breached by a principal or a third party, information regarding comments or complaints about the agent, the principal, or a third party, information regarding an agent acting outside the scope of his, her, or its, authority, and/or any other information regarding or relevant to a relationship between a principal and an agent of the principal.

The database 10H can also include, for each agent who or which utilizes the apparatus 100, the agent's name, address, contact information, e-mail address(es), telephone number(s), principal(s), information regarding the authority or powers, or the scope or limits of same, which are granted to the agent, information regarding whether the principal's written consent is needed to bind the principal, information regarding retainer agreements, retention agreements, employment agreements, agent or agency agreements, between the agent and a principal, historical information regarding past actions or activities of the agent on behalf of a principal, information regarding actions of the principal in response to the agents actions, such as whether the principal accepted, confirmed, rejected, or disavowed, the agents actions or activities, information regarding deals entered into between the principal, the agent, and a third party, information regarding third parties with whom the agent or principal have dealt with or corresponded with, information regarding contracts entered into, information regarding contracts breached by a principal or a third party, information regarding comments or complaints about the agent, the principal, or a third party, information regarding an agent acting outside the scope of his, her, or its, authority, and/or any other information regarding or relevant to a relationship between the agent and his, her, or its, principal.

The database 10H can also include, for each third party who or which utilizes the apparatus 100, the third party's name, address, contact information, e-mail address(es), telephone number(s), historical information regarding past actions or activities of the third party, information regarding actions of the principal in response to the agents actions in dealing with the third party, such as whether the principal accepted, confirmed, rejected, or disavowed, the agents actions or activities, information regarding deals entered into between the third party with an agent or a principal, information regarding agents with whom the third party has dealt with or corresponded with, information regarding contracts entered into, information regarding contracts breached by a principal or a third party, information regarding comments or complaints about the third party, or any other information regarding the third party.

The database 10H can also contain information regarding any and/or all correspondence, e-mails, text messages, audio recordings, and any other information for memorializing any and/or all e-mail message exchanges, text message exchanges, audio recordings, letters, or other communications or correspondence, between any agent and any third party wherein an agent is acting on behalf of, or otherwise representing, a principal. The database 10H can also contain information regarding any and/or all correspondence, e-mails, text messages, audio recordings, and any other information for memorializing any and/or all e-mail message exchanges, text message exchanges, audio recordings, letters, or other communications or correspondence, between any agent and his, her, or its, principal.

The database 10H can also contain any data and/or information regarding the existence of any contracts, agreements, retainer agreements, agent agreements, agency or representative agreements, powers of attorney, retention agreements, employment agreements, consent agreements, agreements formed between a user of the apparatus 100 or his, her, or its, representative, and/or agreements formed between an principal and any third party. The database 10H can also contain digitized or other copies of any of the above-mentioned contracts, agreements, retainer agreements, agent agreements, agency or representative agreements, powers of attorney, retention agreements, employment agreements, consent agreements, agreements formed between a user of the apparatus 100 or his, her, or its, representative, and/or agreements formed between an principal and any third party. The database 10H can also contain any data and/or information regarding terminated agency relationships, terminated representative capacity relationships, complaints regarding agents, complaints regarding principals, complaints regarding third parties, and/or any other information which may be useful, needed, or desired by any user of the apparatus 100 and method of the present invention.

The database 10H can also contain or include data and/or information regarding any of the herein-described users, subscribers, persons, individuals, entities, principals, agents, and third parties who or which may utilize the apparatus 100 and method of the present invention.

The database 10H can also contain information regarding financial or subscriber accounts for any of the herein-described users, subscribers, persons, individuals, entities, principals, agents, and third parties who or which may utilize the apparatus 100 and method of the present invention.

The database 10H can also contain any data and/or information regarding any of the herein-described users, subscribers, persons, individuals, entities, principals, agents, and third parties who or which may utilize the apparatus 100 and method of the present invention. The database 10H can also contain any data and/or information regarding advertisements as well as data and./or information which can be used to disseminated advertisements to any of the herein-described users, subscribers, persons, individuals, entities, principals, agents, and third parties who or which may utilize the apparatus 100 and method of the present invention.

The database 10H can also contain any of the data and/or information described herein as being stored in, processed by, or utilized by, the official records computer 20 and/or any of the user communication devices 30 described herein as being utilized by the apparatus 100 and method of the present invention.

The database 10H can include advertisements and/or commercials, including television, Internet, and/or video and audio, commercials, infomercials, video advertisements, video clips, audio advertisements, audio clips, banner advertisements, button advertisements, text advertisements, graphical, banner and/or button, advertisements, audio-visual advertisements, interactive advertisements of any of the above-described variety, dynamic advertisements, static advertisements, advertisements which can be placed on web pages and/or on frames surrounding viewed or viewable content, logos, icons, and/or any other information which can be utilized as an advertisement or commercial, as well as any data, information, and/or files, etc., regarding same. The advertisements or commercials can be for or corresponding to any good, goods, product, products, service, and/or services, which can be disseminated to any of the herein-described users, subscribers, persons, individuals, entities, principals, agents, and third parties who or which may utilize the apparatus 100 and method of the present invention.

The database 10H can also contain or include information regarding the prices which advertisers are willing to pay to place their respective advertisements or commercials. The database 10H can also contain data and/or information regarding success rates for the various advertisements or commercials stored in the database 10H.

The database 10H can also include marketing materials which can include, but not be limited to, surveys, polls, polling information, and/or questionnaires, such as text surveys, polls, polling information, and/or questionnaires, video surveys, polls, polling information, and/or questionnaires, audio surveys, polls, polling information, and/or questionnaires, graphical, banner and/or button, surveys, polls, polling information, and/or questionnaires, audio-visual surveys, polls, polling information, and/or questionnaires, interactive surveys, polls, polling information, and/or questionnaires, of any of the above-described variety, dynamic surveys, polls, polling information, and/or questionnaires, static surveys, polls, polling information, and/or questionnaires, along with the amounts of compensation, the reward, the rebate, and/or the incentive, for viewing, and/or for participating in, the respective surveys, polls, polling information, and/or questionnaires. The database 10H can also contain any data and/or information for or regarding calculating a respective compensation, reward, rebate, and/or incentive, for any individual, user, customer, entity, or subscriber, who has viewed and/or participated in a survey, poll, and/or questionnaire.

The database 10H can also contain any other materials or information which can be utilized in performing marketing research, market research, marketing planning and strategic planning, and/or any other information which can be used for gathering marketing information. The database 10H can also contain data and/or information regarding the preferences of any of the herein-described users, subscribers, persons, individuals, entities, principals, agents, and third parties who or which may utilize the apparatus 100 and method of the present invention to receive and/or to participate in certain surveys, polls, and/or questionnaires, data and/or information correlating surveys, polls, polling information, and/or questionnaires, with the purchase or sale of certain goods, products, and/or services, and/or any other data and/or information needed and/or desired for facilitating the operation of the apparatus 100 and method of the present invention as described herein.

The database 10H can also contain any and/or all data and/or information needed or desired for enabling the apparatus 100 to perform any of the functionality described herein as being capable of being performed by the apparatus 100 and method of the present invention along with any of the other data and/or information described herein as being utilized by the apparatus 100 in performing any and/or all of the operations and functions described as being performed or provided by the apparatus 100 and method of the present invention.

The database 10H can also contain information regarding agents, attorneys, or representatives, of any kind, including but not limited to, for each agent, attorney, or representative, his, her, its, or their, contact information, address, e-mail address, text message or SMS message number, phone number, representative clients or customers, information regarding any deals of agreements reached by the respective agent, attorney, or representative, area or areas of specialization, comments or referrals from clients or customers, comments of third parties who have had dealings of any kind with the agent, attorney, or representative, template agreements used by the agent, attorney, or representative, past agreements negotiated or drafted by the respective agent, attorney, or representative on behalf of a principal, client, or customer, work product of the agent, attorney, or representative, information regarding past successful deals, agreements, or negotiations performed by or involving the respective agent, attorney, or representative, any marketing materials or information for the respective agent, attorney, or representative, commercials, video clips, discount coupons, or any other type or kind of information which an agent, attorney, or representative may desire to utilize or make available via the apparatus 100 or the central processing computer 10 in order to utilize same in a manner to perform self-promotion and/or to market themselves to prospective principals, clients, or customers.

The database 10H can also contain information regarding principal, clients, or customers, of any kind, including, but not limited to, for each principal, client, or customer, his, her, its, or their, contact information, address, e-mail address, text message or SMS message number, phone number, field of business or expertise, agent, attorney, or representative need requirements, information regarding any deals of agreements reached by the respective principal, client, or customer, area or areas of specialization of need requirements, comments or referrals from agents, attorneys, or representatives, comments of third parties who have had dealings of any kind with the principal, client, or customer, template agreements used by the principal, client, or customer, past agreements negotiated or drafted by or for the respective principal, client, or customer, work product of the principal, client, or customer, information regarding past successful deals, agreements, or negotiations performed for or on behalf of or involving the respective principal, client, or customer, any marketing materials or information for the respective principal, client, or customer, commercials, or video clips, or any other type or kind of information which a principal, client, or customer, may desire to utilize or make available via the apparatus 100 or the central processing computer 10 in order to utilize same in a manner to perform self-promotion and/or to market themselves to prospective agents, attorneys, or representatives.

The database 1011 can also include any information about any user, principal, client, customer, agent, attorney, representative, or third party, which can be provided on or from a social networking website, company, or entity, which can allow any of the herein-described users, principals, clients, customers, agents, attorneys, representatives, or third parties, to post or provide any information regarding themselves which may be useful for marketing themselves to others. For example, an individual such, but not limited to, an athlete, an actor or actress or one aspiring to become an actor or an actress, a celebrity, an entertainer, a journalist, a television personality, or simply any individual or entity seeking to promote themselves, secure representation, or perform any other activity which can be facilitated by the apparatus 100 and method of the present invention, can post work samples, video clips of performances or activities, reviews by others, information and links to information, including audio or video information or links to same regarding upcoming or future performances, and/or any other information which can provided to or accessed by any agent, attorney, or representative which may be interested in representing or acting on behalf of the individual.

The database 10H can also contain any link or link to a website of any of the herein-described users, principals, clients, customers, agents, attorneys, representatives, or third parties, or any other individuals or entities, resume information, work samples, performance measures, statistics, ratings, grades, video recordings of performance, personal statements, commercials, marketing materials, brochures, video and audio clips or recordings, friends, followers, schedules of events or activities involving a respective principal, client, customer, agent, attorney, representative, or third party, or any other individual or entity, or any other information or material that a respective principal, client, customer, agent, attorney, representative, or third party, or any other individual or entity, might post to or on a website or to or on a social networking website.

The central processing computer 10 also includes a transmitter(s) 10I, which is connected to the CPU 10A, and which can include one transmitter or any number of transmitters, for transmitting signals and/or data and/or information to any one or more of any other central processing computer(s) 10, the official records computer(s) 20, and any number of user communication devices 30.

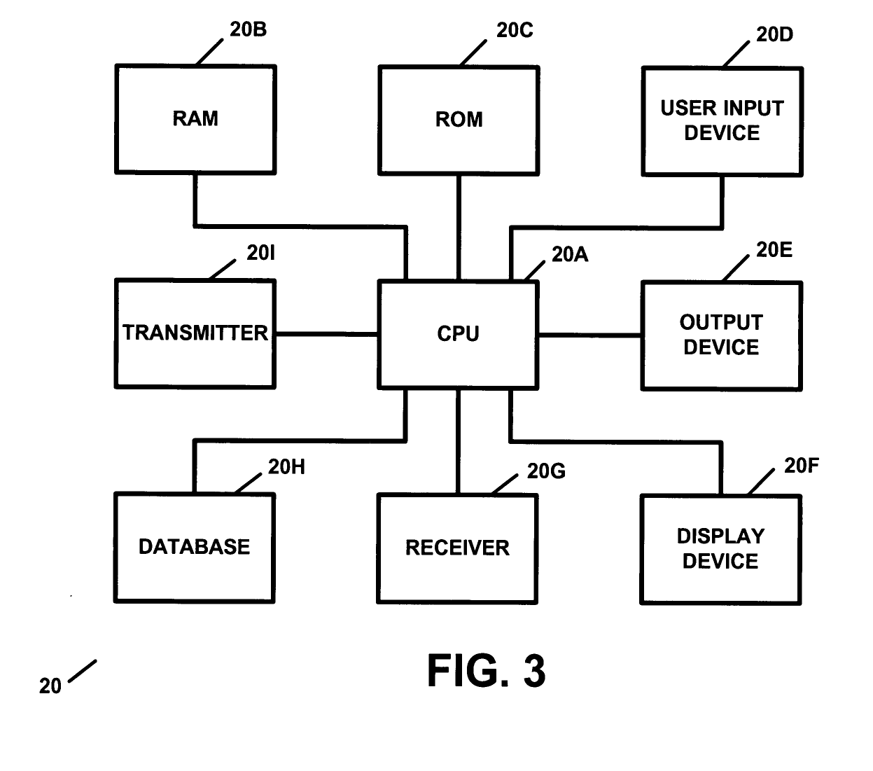

FIG. 3 illustrates the official records computer 20 of FIG. 1, in block diagram form. The official records computer 20, in the preferred embodiment, is a network computer or computer system and can consist of, or can include, a single computer or computer system or a plurality of computers or computer systems.

With reference to FIG. 3, the official records computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The official records computer 20 also includes a random access memory device(s) (RAM) 20B and a read only memory device(s) (ROM) 20C, each of which is connected to the CPU 20A, a user input device 20D which is connected to the CPU 20A, for entering data and/or commands into the official records computer 20, and which can include any one or more of a keyboard, a scanner, a user pointing device, such as, for example, a mouse, a touch pad, and/or an audio input device and/or a video input device, etc., if desired. The input device(s) is also connected to the CPU 20A. The official records computer 20 also includes an output device 20E such as a printer, a modem, a fax/modem, or other output device, which is connected to the CPU 20A, and which provides data and/or information to the operator or user of the official records computer 20 or to any other entity. The official records computer 20 also includes a display device 20F, which is connected to the CPU 20A, which displays data and/or information to a user or operator.

The official records computer 20 also includes a receiver 20G, which is also connected to the CPU 20A, and which can include one receiver or any number of receivers, for receiving signals and/or data and/or information from any one or more of any central processing computer(s) 10, any other official records computer 20, and/or any number of user communication devices 30.

The official records computer 20 also includes a database 20H which can contain any of the data and/or information described herein as being contained in the database 10H of the central processing computer 10.

The official records computer 20 also includes a transmitter(s) 201, which is connected to the CPU 20A, and which can include one transmitter or any number of transmitters, for transmitting signals and/or data and/or information to any one or more of the central processing computer(s) 10, any other official records computer(s) 20, and any number of user communication devices 30.

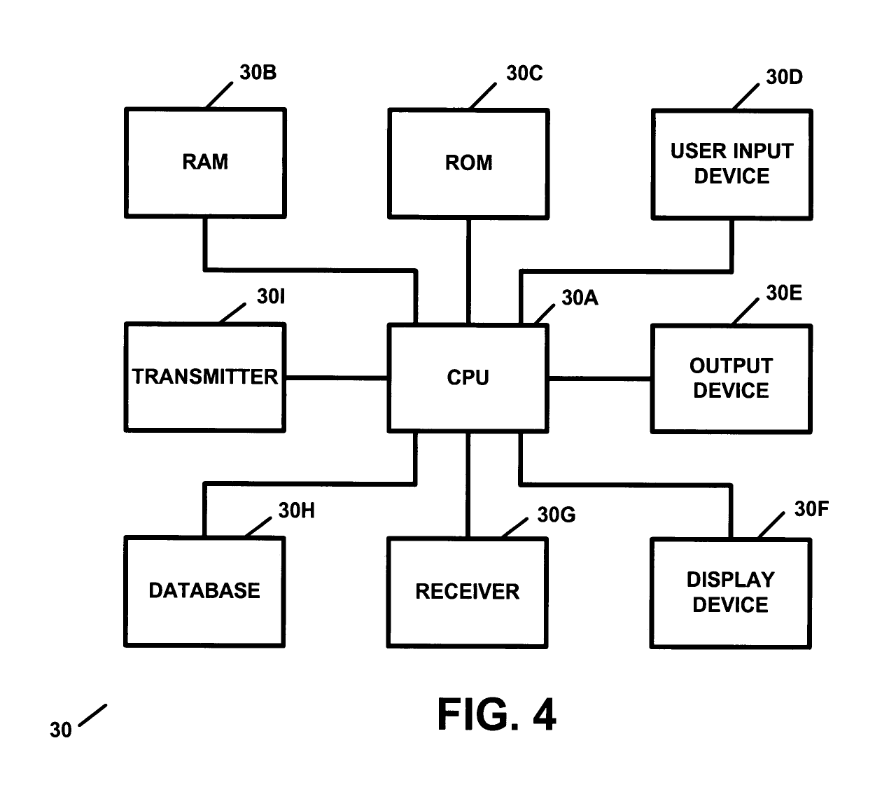

FIG. 4 illustrates the user communication device 30 of FIG. 1, in block diagram form. The user communication device 30, in the preferred embodiment, can be any computer or communication device, such as, but not limited to, a personal computer, a home computer, a laptop computer, a handheld computer, a personal communication device, a personal communication services device, a wireless telephone, wireless communication device, a cellular telephone, a personal digital assistant, a “smart” telephone, a mobile telephone, a video telephone, a videophone, a personal communication services device, or a watch, or any other communication device.

With reference to. FIG. 4, the user communication device 30 includes a central processing unit or CPU 30A, which in the preferred embodiment, is a microprocessor. The CPU 30A may also be a microcomputer, a minicomputer, a macro-computer, and/or a mainframe computer, depending upon the application.

The user communication device 30 also includes a random access memory device(s) (RAM) 30B and a read only memory device(s) (ROM) 30C, each of which is connected to the CPU 30A, a user input device 30D which is connected to the CPU 30A, for entering data and/or commands into the user communication device 30, and which can include any one or more of a keyboard, a scanner, a user pointing device, such as, for example, a mouse, a touch pad, and/or an audio input device and/or a video input device, etc., if desired. The input device(s) is also connected to the CPU 30A. The user communication device 30 also includes an output device 30E such as a printer, a modem, a fax/modem, or other output device, which is connected to the CPU 30A, and which provides data and/or information to the operator or user of the user communication device 30 or to any other entity. The user communication device 30 also includes a display device 30F, which is connected to the CPU 30A, which displays data and/or information to a user or operator.

The user communication device 30 also includes a receiver 20G, which is also connected to the CPU 20A, and which can include one receiver or any number of receivers, for receiving signals and/or data and/or information from any one or more of the central processing computer(s) 10, the official records computer 20, and/or any other of a number of user communication devices 30.

The user communication device 30 also includes a database 30H which can contain any of the data and/or information described herein as being contained in the database 10H of the central processing computer 10 or in the database 20H of the official records computer 20. The database 30H can also contain any information regarding the user, which can be personal information, confidential information, or any other information.

The user communication device 30 also includes a transmitter(s) 301, which is connected to the CPU 30A, and which can include one transmitter or any number of transmitters, for transmitting signals and/or data and/or information to any one or more of the central processing computer(s) 10, the official records computer(s) 20, and any one or more of any number of other user communication devices 30.

The apparatus 100 and method of the present invention can be utilized in many different ways to provide and/or to process information pertaining to and/or relating to a principal/agent relationship and/or any activity or activities involving an agent and a third party. The apparatus 100 and method of the present invention can also be utilized in many ways in order to provide information regarding a principal/agent relationship and/or to provide information regarding any type or kind of activities, communications, correspondences, attempted transactions, alleged transactions, alleged agreements, completed transactions, completed agreements, binding agreements, non-binding agreements, agreements to agree, alleged agreements to agree, actions by a principal, actions by an agent, and/or actions by a third party, and/or any information regarding a principal, an agent, or a third party.

In a preferred embodiment, the apparatus 100 and method of the present invention can be utilized by a principal to register information regarding an agent of or for the principal. In another preferred embodiment, the apparatus 100 and method of the present invention can be utilized by an agent to register information regarding a principal of the agent. In this manner, information regarding a principal/agent relationship can be registered with the apparatus 100 and can be made available for third parties or any other persons, individuals, or entities, who or which desire to ascertain the existence or to confirm a principal/agent relationship.

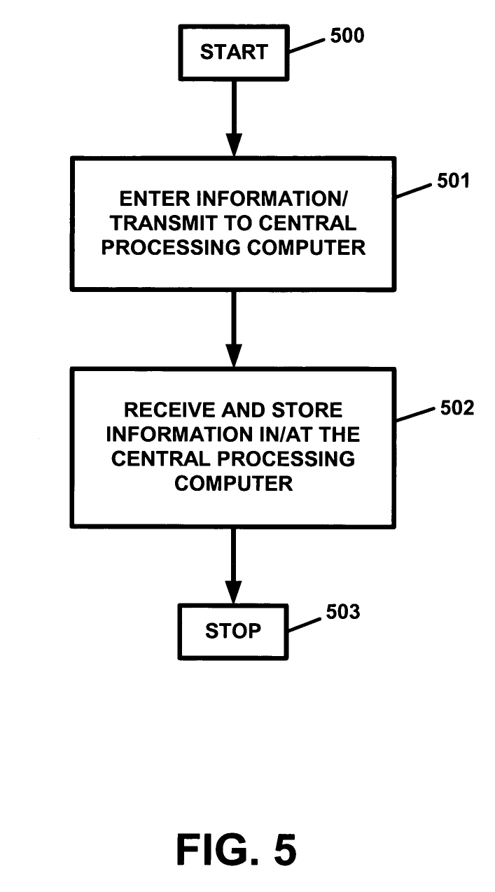

FIG. 5 illustrates a preferred embodiment method for utilizing the apparatus 100 and method of the present invention, in flow diagram form. With reference to FIG. 5, the operation of the apparatus 100 will commence at step 500. At step 501, a principal, who or which can be any person, individual, or entity, can access the central processing computer 10 using any user communication device 30.

At step 501, the principal can enter, and transmit to the central processing computer 10, information regarding his, her, or its identity, firm or company name, address and contact information, telephone number, e-mail address, text message telephone number, or any other contact information, information regarding the name or identity of his, her, or its, agent, the name of the agent, the name of the agent's firm, company, or employer, contact information, telephone number, e-mail address, text message telephone number, or any other contact information, information regarding the scope of the authority of the agent to act on behalf of the principal, information regarding permitted activities or limitations on activities of the agent, information regarding powers or rights granted to the agent, information regarding powers or rights reserved by the principal, information regarding whether or not the agent can act on behalf of the principal without the principal's written or express consent, information regarding whether or not the principal's written or express consent is required before the principal will agree to be bound, information regarding a requirement or a request that the principal, and/or his, her, or its attorney(s) of other representatives be sent a notification message or an alert message, or be notified of and/or before, during, or after, any correspondence, communication, negotiation, or any other activity or activities of the agent on behalf of the principal or any correspondence, communication, negotiation, or any other activity or activities of the agent with any third party or any other person, individual or entity, information regarding a request to be notified when a third party, individual, person, or entity, requests information regarding the principal or his, her, or its, agent, information regarding whether the principal requires that all correspondence or communication between the agent and a third party be recorded and stored in the apparatus 100, and any other information which a principal may desire to post about his, her, or its, agent, and their principal and agent relationship.

At step 502, the central processing computer 10 can receive and store, in the database 10H, the information entered by the principal and transmitted from the user computer 30. Thereafter, the operation of the apparatus 100 will cease at step 503 and the information provided by the principal can be available for retrieval by any user for any appropriate purpose.

In another preferred embodiment, the apparatus 100 and method of FIG. 5 can be utilized by an agent, or by a third party or any other individual, person, or entity, acting as a principal or as an agent for another, in order to register information regarding his, her, or its agency relationship with his, her, or its, principal. In this embodiment, the agent can access the central processing computer 10 via a user communication device 30 and enter and transmit the name of the agent's firm, company, or employer, contact information, telephone number, e-mail address, text message telephone number, or any other contact information, information regarding the scope of the authority of the agent to act on behalf of the principal, information regarding permitted activities or limitations on activities of the agent, information regarding powers or rights granted to the agent, information regarding powers or rights reserved by the principal, information regarding whether or not the agent can act on behalf of the principal without the principals written or express consent, information regarding whether or not the principal's written or express consent is required before the principal will agree to be bound, information regarding a requirement or a request that the principal, and/or his, her, or its attorney(s) of other representatives be sent a notification message or an alert message, or be notified of and/or before, during, or after, any correspondence, communication, negotiation, or any other activity or activities of the agent on behalf of the principal or any correspondence, communication, negotiation, or any other activity or activities of the agent with any third party or any other person, individual or entity, information regarding whether the principal requires that all correspondence or communication between the agent and a third party be recorded and stored in the apparatus 100, and any other information which a principal may desire to post about his, her, or its, agent, and their principal and agent relationship.

The agent can enter and transmit information regarding his, her, or its identity, firm or company name, address and contact information, information regarding the name or identity of his, her, or its, principal, the name of the principal, the name of the principal's firm, company, or employer, information regarding the scope of the authority of the agent to act on behalf of the principal, information regarding permitted activities or limitations on activities of the agent, information regarding powers or rights granted to the agent, information regarding powers or rights reserved by the principal, information regarding whether or not the agent can act on behalf of the principal without the principal's written or express consent, information regarding whether or not the principal's written or express consent is required before the principal will agree to be bound, information regarding requirements that the principal be notified of, before, during, or after, any correspondence, information regarding a request to be notified when a third party, individual, person, or entity, requests information regarding the agent or his, her, or its, principal, information regarding whether the principal requires that all correspondence or communication between the agent and a third party be recorded and stored in the apparatus 100, and any other information which an agent may desire to post about his, her, or its, principal, and their principal and agent relationship.

In another preferred embodiment, any third party, individual, person, or entity, may be a principal or an agent for a principal and can register as such with the apparatus 100 in the manner described herein.

In another preferred embodiment, the apparatus 100 and method of the present invention can be utilized by any third party, individual, person, entity, or any agent, in order to ascertain information regarding any principal and/or the principal's agent, or any information regarding their principal/agent relationship.

The respective third party, individual, person, entity, or agent, can utilize the apparatus 100 in order to determine information regarding any principal or agent registered with the apparatus 100. For example, the apparatus 100 can be utilized to allow any third party, individual, person, entity, or agent, to determine or ascertain the identify of an agent of a principal, obtain agent contact information, telephone number, e-mail address, text message telephone number, or any other contact information, information regarding the scope of the authority of the agent to act on behalf of the principal, determine or ascertain information regarding permitted activities or limitations on activities of the agent, determine or ascertain information regarding powers or rights granted to the agent, determine or ascertain information regarding powers or rights reserved by the principal, determine or ascertain information regarding whether or not the agent can act on behalf of the principal without the principal's written or express consent, determine or ascertain information regarding whether or not the principal's written or express consent is required before the principal will agree to be bound, determine or ascertain information regarding a requirement or a request that the principal, and/or his, her, or its attorney(s) of other representatives be sent a notification message or an alert message, or be notified of and/or before, during, or after, any correspondence, communication, negotiation, or any other activity or activities of the agent on behalf of the principal or any correspondence, communication, negotiation, or any other activity or activities of the agent with any third party or any other person, individual or entity, determine or ascertain information regarding whether the principal requires that all correspondence or communication between the agent and a third party be recorded and stored in the apparatus 100, or determine or ascertain and any other information regarding the principal or the agent for the principal.

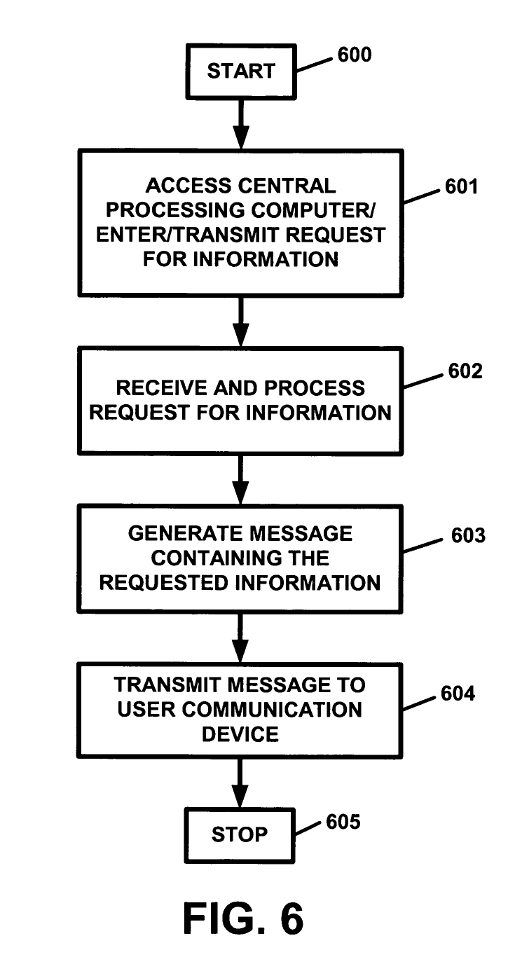

FIG. 6 illustrates anther preferred embodiment method for utilizing the apparatus 100 and method of the present invention, in flow diagram form. With reference to FIG. 6, the operation of the apparatus 100 commences at step 600. At step 601, the respective third party, individual, person, or entity, can access the central processing computer 10 via a user communication device 30. At step 601, the respective third party, individual, person, or entity, can enter a request for information regarding the principal or the principal's agent which request for information can include, but not be limited to, a request for information to determine or ascertain the identify of an agent of a principal, obtain agent contact information, telephone number, e-mail address, text message telephone number, or any other contact information, information regarding the scope of the authority of the agent to act on behalf of the principal, determine or ascertain information regarding permitted activities or limitations on activities of the agent, determine or ascertain information regarding powers or rights granted to the agent, determine or ascertain information regarding powers or rights reserved by the principal, determine or ascertain information regarding whether or not the agent can act on behalf of the principal without the principal's written or express consent, determine or ascertain information regarding whether or not the principal's written or express consent is required before the principal will agree to be bound, determine or ascertain information regarding a requirement or a request that the principal, and/or his, her, or its attorney(s) of other representatives be sent a notification message or an alert message, or be notified of and/or before, during, or after, any correspondence, communication, negotiation, or any other activity or activities of the agent on behalf of the principal or any correspondence, communication, negotiation, or any other activity or activities of the agent with any third party or any other person, individual or entity, determine or ascertain information regarding whether the principal requires that all correspondence or communication between the agent and a third party be recorded and stored in the apparatus 100, or determine or ascertain and any other information regarding the principal or the agent for the principal.

At step 601, the request for information can be transmitted to the central processing computer 10. At step 602, the central processing computer 10 can receive and process the request for information. At step 603, the central processing computer 10 can generate a message containing the information requested. At step 604, the central processing computer 10 can transmit the message to the user communication device 30 where the respective third party, individual, person, or entity, can review the information contained in the message an utilize same in any appropriate manner.

Thereafter, the operation of the apparatus will cease at step 605. In another preferred embodiment, the apparatus 100 and method of the present invention can be utilized to provide a notification message or an alert message to a principal or an agent when information is requested by the respective third party, individual, person, or entity about the principal or the agent. In this embodiment, the central processing computer can, at step 604, also generate and transmit a notification message or an alert message to a user communication device 30 associated with or used by the principal or the agent. The notification message or alert message can contain information regarding the identity of the requesting third party, individual, person, or entity, the information contained in the request for information, and/or the information contained in the message sent to the requesting third party, individual, person, or entity. In this regard, the apparatus 100 and method of the present invention can provide a principal or the principal's agent with a notification that a respective third party, individual, person, or entity, has inquired about them, and what information was sought by that respective third party, individual, person, or entity.

In another preferred embodiment, a third party may locate and identify an agent for a principal and can utilize the apparatus 100 and method of the present invention in order to make contact with, correspond with, negotiate with, and enter into agreements or contracts, with the agent and/or the principal via the agent. In another preferred embodiment, the apparatus 100 can transmit a notification message or an alert message to notify or inform the principal, such as by e-mail message, instant message, text message, automated telephone message to a telephone, a landline telephone, a cellular or wireless telephone, or any other communication device or user communication device 30.

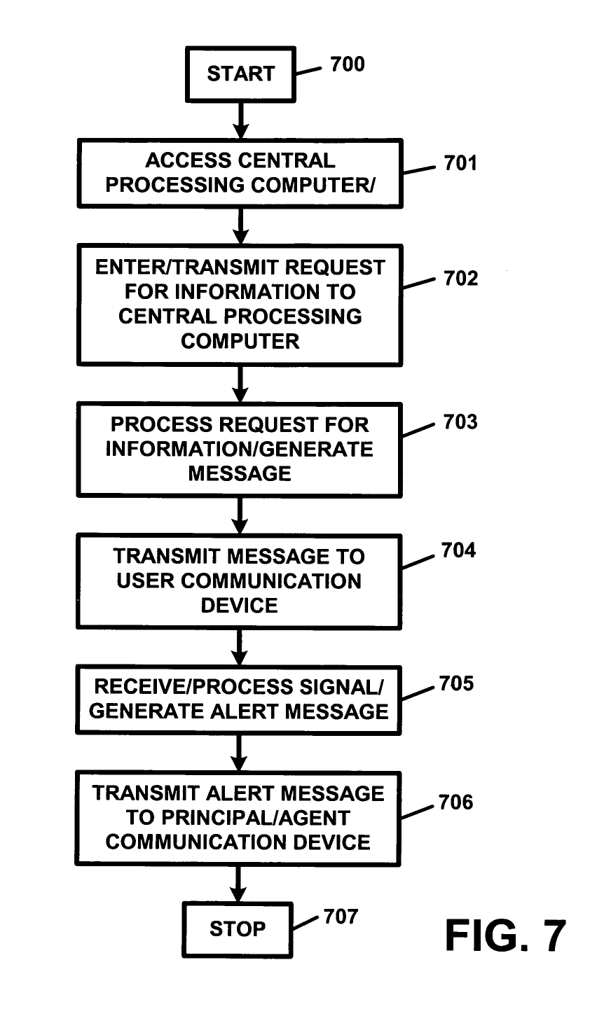

FIG. 7 illustrates yet another preferred embodiment method of operation of the apparatus 100 and method of the present invention. With reference to FIG. 7, the operation of the apparatus 100 commences at step 700. At step 701, the third party, who can be a principal or an agent for a principal, can access the central processing computer 10 using the user communication device 30. At step 702, the third party can enter and transmit, to the central processing computer 10, a request for information regarding a principal, so as to determine if the principal has an agent and, if so, the identify of the agent, or a request for information regarding an agent of the principal. The respective request for information can include a request for contact information for the respective principal or agent.

At step 703, the central processing computer 10 can, in the case of a request for information regarding the principal, process the request for information and identify an agent for the principal, or, in the case of a request for information regarding the agent of a principal, process the request for information regarding the agent. At step 703, the central processing computer 10 can generate a message containing contact information for the agent which can include, but not be limited to, an e-mail address, an instant message or text message number, a telephone number, a cellular, a mobile, or a wireless telephone number, or any other contact information. At step 703, the central processing computer can record and store all pertinent information regarding the third party's request for information.

At step 704, the central processing computer 10 can transmit the message to the user communication device 10 used by the third party. At step 705, the third party can, via the user communication device 30, transmit a signal to the central processing computer 10 indicating that the third party desires or intends to contact the agent for the principal in order to conduct business, negotiate a contract, negotiate an agreement, enter into an agreement or a contract, negotiate a settlement in the case where a dispute or a lawsuit exists or is pending between the principal and a party represented by the third party, compromise a dispute or lawsuit, settle a dispute or lawsuit, or otherwise reach an agreement, accord, or settlement, or to put an end to a dispute or a pending lawsuit between the principal and a party represented by the third party.

At step 705, the central processing computer 10 can receive and process the signal, record information regarding same and generate and transmit a notification message or an alert message containing information regarding the third party's intention to contact the agent of the principal. At step 706, the central processing computer 10 can transmit the notification message or alert message to the user communication device 30 of the principal and/or to the user communication device 30 of the agent of the principal. Thereafter, the operation of the apparatus 100 will cease at step 707.

In another preferred embodiment, the apparatus 100 and method of the present invention can provide an electronic, virtual, on-line, or web-based, forum, or a chat room, or other forum, in which or via which an agent of a principal, the principal himself, herself, or itself, and the third party, can engage in discussions, communications, correspondences, negotiations, and/or any other activities, in order to conduct business, negotiate a contract, negotiate an agreement, enter into an agreement or a contract, negotiate a settlement in the case where a dispute or a lawsuit exists or is pending between the principal and a party represented by the third party, compromise a dispute or lawsuit, settle a dispute or lawsuit, or otherwise reach an agreement, accord, or settlement, to put an end to a dispute or a pending lawsuit between the principal and a party represented by the third party.

In this preferred embodiment, the respective principal, agent, and third party, can agree to conducting their discussions, communications, correspondences, negotiations, and/or any other activities, via the electronic, virtual, on-line, or web-based, forum, or a chat room, or other forum, and can agree to any terms and conditions either dictated by same or otherwise agreed to by the parties.

In the preferred embodiment, the respective electronic, virtual, on-line, or web-based, forum, or a chat room, or other forum, can include, record, and store, any and all text or written correspondence or communications, recordings of any and all off-line telephone conversations or conference calls, or recordings of any video conference calls, between the parties, any and all draft agreements exchanges between the parties, and any other information communicated or exchanged between the parties so as to provide a complete and comprehensive record of all discussions, communications, correspondences, negotiations, and/or any other activities. Audio recordings, video recordings, pictures, photographs, and any other audio or video information evidencing all discussions, communications, correspondences, negotiations, and/or any other activities can also be recorded and stored. In this manner, a complete record of any and all discussions, communications, correspondences, negotiations, and/or any other activities, between the parties can be recorded and stored.

The parties can agree beforehand that any and all discussions, communications, correspondences, negotiations, and/or any other activities, relied upon by the parties must be recorded and stored using the apparatus 100 and method of the present invention. Such an agreement can serve to prevent later disputes regarding what has transpired in the respective discussions, communications, correspondences, negotiations, and/or any other activities.

In a preferred embodiment, the parties, including the agent, the principal, and the third party, can be provided with information for accessing a secure electronic forum, virtual meeting room, or chat room, or other virtual or other forum. The parties, including the agent, the principal, and the third party, can be provided with information for accessing a secure and recorded conference call forum or a recorded video conference call forum.

In another preferred embodiment, the secure electronic forum, virtual meeting room, or chat room, or other virtual or other forum (hereinafter “the electronic forum”) can also display prominently any messages, terms, or conditions, of any and all discussions, communications, correspondences, negotiations, and/or any other activities, such as, but not limited to, “Theses discussions are not binding on the Principal without the Principal's express written consent”, “The agent is not authorized to bind the Principal”, “The Agent is authorized to bind the Principal”, “The Third Party is not authorized to bind their Principal.”, “The Third Party is authorized to bind their Principal”, “All discussions are Confidential or subject to F.R.E. 408 or more stringent confidentiality.”, minimum requirements for agreement or settlement, or any other information which either the principal, the agent, or the third party, or the third party's principal, wants or requires to be posted. Electronic forum meetings can be scheduled by the agent, the third party, the principal of the agent, and/or the principal of the third party.

In another preferred embodiment, the central processing computer 10 or the apparatus 100 can generate and transmit to any one or more of the agent, the third party, the principal of the agent, or the principal of the third party, an electronic meeting notification message which can be transmitted from the central processing computer 10 to the user communication device 30 of the respective agent, the third party, the principal of the agent, or the principal of the third party.

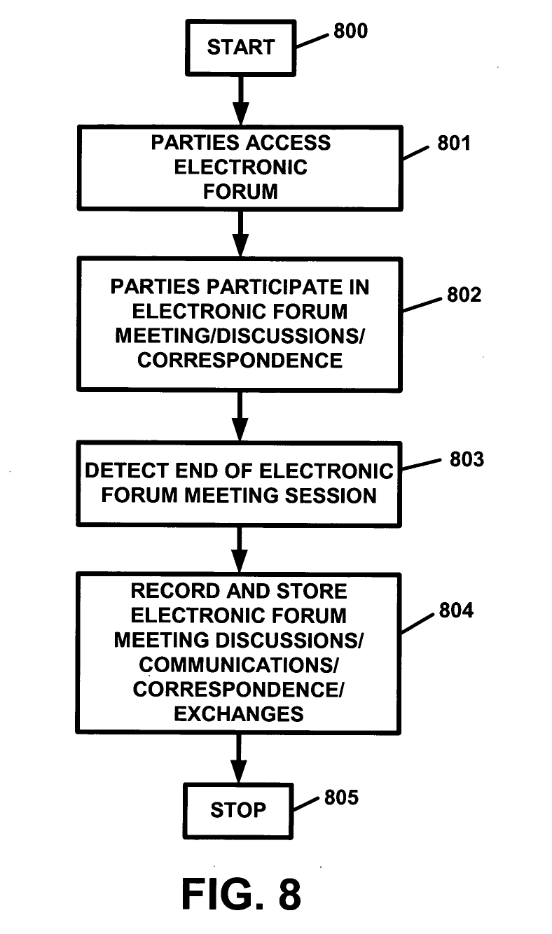

FIG. 8 illustrates yet another preferred embodiment method of operation of the apparatus 100 and method of the present invention. With reference to FIG. 8, the operation of the apparatus 100 commences at step 800. At step 801, the agent and the third party, and/or their respective principal or principals (“the parties”), can access the electronic forum in order to participate in an electronic forum meeting. The electronic forum meeting can include or involve the parties or participants engaging in any and/or all forms of types of discussions, communications, correspondences, negotiations, and/or any other activities, chat messaging, e-mail messaging, instant text messaging, telephone conference calls, video conference calls, or any other type or form of communications or information exchange between or involving the parties or participants.

If the parties are accessing the electronic forum for the first time to begin discussions, communications, correspondences, negotiations, and/or any other activities, the electronic forum will have no previously save records of previous discussions, communications, correspondences, negotiations, and/or any other activities. If the parties have had previous discussions, communications, correspondences, negotiations, and/or any other activities, in the electronic forum, then all records of these previous discussions, communications, correspondences, negotiations, and/or any other activities, will be available in the electronic forum for them the see and access. Any previously recorded telephone conference calls will also be recorded, stored and can be accessed. Any previously recorded video conference calls will also be recorded, stored and can be accessed.

In a preferred embodiment, any and all telephone conference calls or video conference are to be considered to be part of, or included in, the record of any electronic meeting discussions, communications, correspondences, negotiations, and/or any other activities. In this manner, a complete and comprehensive record of all discussions, communications, correspondences, negotiations, and/or any other activities, between or involving all of the parties can be recorded and stored for later use.

In another preferred embodiment, in the case of a principal who has not joined, or who has not been notified of the discussions, communications, correspondences, negotiations, and/or any other activities, the central processing computer 10, at step 801, can generate and transmit an electronic forum meeting notification message and transmit same the user communication device 30 used by or associated with the principal. In the case when the agent or the third party has not joined the electronic forum meeting, the central processing computer 10 can also generate and transmit, at step 801, an electronic forum meeting notification message and transmit same the user communication device 30 used by or associated with the agent or the third party.

At step 802, any parties who have accessed the electronic forum, which will include at least the agent and third party, and possible one or both of the principals, can begin or resume, whichever the case may be, their discussions, communications, correspondences, negotiations, and/or any other activities. At any time, they may enter and exchange comments, communications, or correspondence, input, insert, or exchange documents, join in a recorded conference call or conference calls, join I a recorded video conference call, or perform any other activity related to the discussions, communications, correspondences, negotiations, and/or any other activities between the parties to the discussions, communications, correspondences, negotiations, and/or any other activities. At any time, a principal or both principals can join in to enter their own comments. A principal can also terminate or table all discussions at any time.

The discussions, communications, correspondences, negotiations, and/or any other activities can occur in the electronic forum until the parties or participants decide to end a session or to end the discussions, communications, correspondences, negotiations, and/or any other activities. At step 803, the central processing computer 10 can process information regarding a detection of an end of the session or an end to the discussions, communications, correspondences, negotiations, and/or any other activities. At step 804, the central processing computer 10 can record and store any and all discussions, communications, correspondences, negotiations, and/or any other activities, any exchanged documents, and any recorded telephone calls or video conference calls.

The recorded and stored discussions, communications, correspondences, negotiations, and/or any other activities, any exchanged documents, and any recorded telephone calls or video conference calls, can be retrieved at any time to provide a record, and evidence if need be, of any and all discussions, communications, correspondences, negotiations, and/or any other activities, any exchanged documents, and any recorded telephone calls or video conference calls, exchanged by the parties or participated in by the parties. Thereafter, the operation of the apparatus 100 will cease at step 805.

In another preferred embodiment, the principal of the agent may access and/or monitor the discussions, communications, correspondences, negotiations, and/or any other activities, any exchanged documents, and any recorded telephone calls or video conference calls, in the electronic forum at any time. In another preferred embodiment, any other agent, attorney, or representative, of the principal may access and/or monitor the discussions, communications, correspondences, negotiations, and/or any other activities, any exchanged documents, and any recorded telephone calls or video conference calls, in the electronic forum at any time.

In another preferred embodiment, the principal can, at any time, access the central processing computer 10, and can terminate discussions, communications, correspondences, negotiations, and/or any other activities, between the parties, can terminate an agent, can disavow an agent's actions, can agree to an agent's actions, can supersede an agent's actions, or can accept or reject an offer or an agreement (“the principal's action(s)”). In another preferred embodiment, the central processing computer 10 can generate a message containing information regarding the principal's action(s) and can transmit the message to a respective user communication device 30 of each of the agent and the third party.

In a preferred embodiment, any party to the electronic forum discussions, communications, correspondences, negotiations, and/or any other activities, any exchanged documents, and any recorded telephone calls or video conference calls, or any agent, attorney, or representative of same, can access the central processing computer 10 can request and retrieve any and/or all of the discussions, communications, correspondences, negotiations, and/or any other activities, any exchanged documents, and any recorded telephone calls or video conference calls, which took place in the electronic forum between the parties.

In another preferred embodiment, the apparatus 100 and method of the present invention can transcribe any audio from any of the herein-described telephone calls or video conference calls into text information which can be stored in connection with any of the herein-described electronic forum discussions, communications, correspondences, negotiations, and/or any other activities. In this embodiment, the apparatus 100, the central processing computer 10, and/or the official records computer 20, can be equipped or provided with audio to text transcription software and/or hardware.

In another preferred embodiment, the apparatus 100 and method of the present invention can translate any text information from one language into another language and came store any such translations. In this embodiment, the apparatus 100, the central processing computer 10, and/or the official records computer 20, can be equipped or provided with any language translation software and/or hardware for performing language translation from one language into any number of languages.

In another preferred embodiment, the apparatus 100 and method of the present invention, and in particular, the central processing computing 10 can generate a notification message or an alert message whenever a third party inquires about, communicates with, or corresponds with, an agent or seeks to obtain information regarding the principal or the principal's agent and can transmit same to a user communication device 30 of the principal or to a user communication device 30 of the agent or to an e-mail server of a respective principal or agent in order to provide notification to, or to inform.

In another preferred embodiment, the apparatus 100 and method of the present invention can be utilized to provide a forum or venue in which, or a communication forum or private forum, in which a principal can communicate instructions, directives, or other information, to an agent as well as to allow an agent to communicate information or suggestions, or an offer, to a principal. In a preferred embodiment, the respective communication, instruction(s), directive(s), suggestion(s), or information, or offer, can be entered into a user communication device 30, which can be used by a respective principal or agent, and can be transmitted in a message which can be sent from the user communication device 30 to the central processing computer 10.

The central processing computer 10 can receive and process the message, can identify the sender of the message as a principal or an agent, can determine the agent for the principal or the principal of the agent (“the identified agent” or “the identified principal”, respectively), and can transmit the message to the user communication device 30, or to an e-mail server of, for, or associated with, the identified agent or the identified principal. In this manner, the apparatus 100 and method of the present invention can be used to provide or facilitate a forum or venue in which a principal and his, her, or its, agent can communicate. Any and/or all of the herein-described messages can be recorded, stored, and/or archived in the central processing computer 10 and any of the herein-described messages can be maintained as “Confidential”. Any and/or all of the herein-described messages can also be stored in the official records computer 20. Any and/or all of the herein-described messages can also be stored in and/or downloaded to and/or stored in a user communication device 30 of a respective user, principal, or agent.

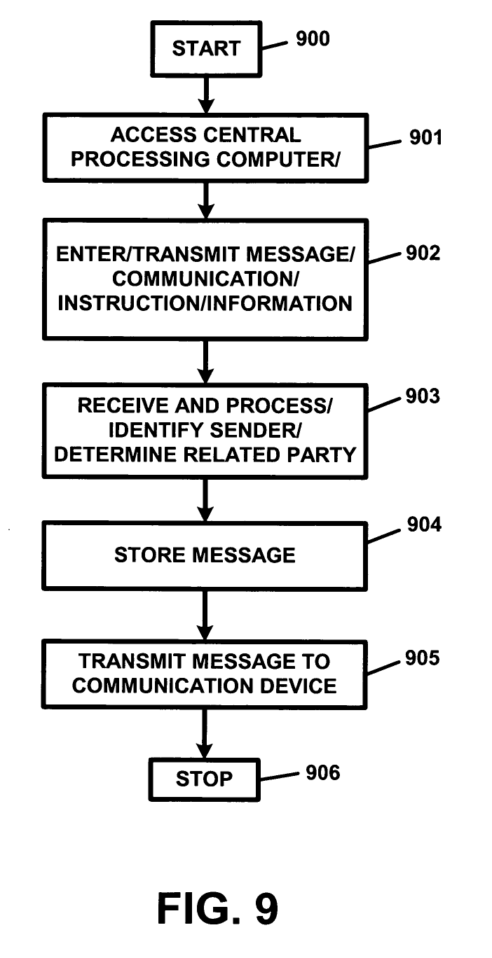

FIG. 9 illustrates another preferred embodiment operation of the apparatus of FIG. 1, in flow diagram form. With reference to FIG. 9, the operation of the apparatus 100 commences at step 900. At step 901 a user, who can be either a principal or an agent can access the central processing computer 10 using his or her user communication device 30. At step 901, the respective principal or agent can enter a respective communication, instruction(s), directive(s), suggestion(s), or information, as a message into the user communication device 30. At step 902, the message can be transmitted to the central processing computer 10. At step 903, the central processing computer 10 can receive and process the message, can identify the sender of the message as a principal or an agent, and can determine or identify the agent for the principal or the principal of the agent (“the identified agent” or “the identified principal”, respectively). At step 904, the central processing computer can store the message.

At step 905, the central processing computer 10 can transmit the message to the user communication device 30, or to an e-mail server of, for, or associated with, the identified agent or the identified principal. Thereafter, the operation of the apparatus 100 can cease at step 906.

In another preferred embodiment, at step 905, the apparatus 100 or the central processing computer can also facilitate communications or correspondence between the principal and agent or agent and principal. In this manner, the apparatus 100 and method of the present invention can be used to provide a forum or venue in which a principal and his, her, or its, agent can communicate or correspond. Any and/or all of the herein-described messages or offers and counteroffers can be recorded, stored, and/or archived in the central processing computer 10 and any of the herein-described messages can be maintained as “Confidential”. Any and/or all of the herein-described messages can also be stored in the official records computer 20. Any and/or all of the herein-described messages can also be stored in and/or downloaded to and/or stored in a user communication device 30 of a respective user, principal, or agent.

In another preferred embodiment, the apparatus 100 and method of the present invention can be utilized in order to allow a principal, client, customer, or any individual or entity (hereinafter “principal” or “prospective principal”), to search for, identify, or locate, an agent, an attorney, or a representative. In a preferred embodiment, an agent, attorney, or representative, can post information regarding himself, herself, or itself, which information can include, but is not limited to, any of the data or information described herein as being stored in the database 10H for, regarding, or relating to, the agent, attorney, or representative.

In a preferred embodiment, the principal or prospective principal can access the central processing computer 10 using a user communication device 30, can enter search criteria regarding a desired type or kind of agent, attorney, or representative, and can transmit a search request to the central processing computer 10. The central processing computer 10 can receive and process the search request. The central processing computer 10 can identify an agent, attorney, or representative, or any number of agents, attorneys, or representatives, and can generate a search results message which can contain information regarding any identified agent(s), attorney(s) or representative(s). The central processing computer 10 can transmit the search results message to the user communication device 30.

The search results message can also contain any information, or a link or links to such information, for each identified agent, attorney, or representative. The information can be or can include, but is not limited to, any of the information described herein as being stored in the database 10H for, regarding, or relating to, the agent, attorney, or representative. The principal or prospective principal can review the information in the search results message and/or any information regarding any identified agent, attorney, or representative, and decide whether or not to hire, engage, or retain the services of, an identified agent, attorney, or representative. Thereafter, the principal or prospective principal can contact the agent, attorney, or representative.

The principal or prospective principal can also hire, engage, or retain the services or, the agent, attorney, or representative via the central processing computer 10. The central processing computer 10 can also register the agent, attorney, or representative as being the respective agent, attorney, or representative, of the principal or prospective principal, so that that information is available via the central processing computer 10 to the World at large. Information regarding the agent's, attorney's, or representative's authorization to act on behalf of the principal in any number of situations and any other information can also be stored and provided by the central processing computer 10.

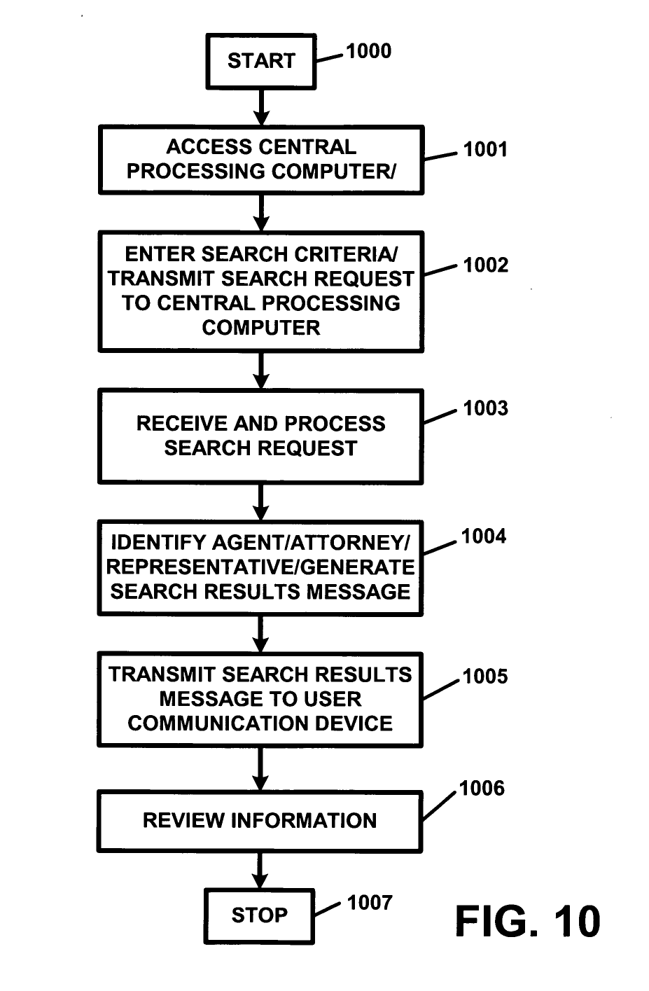

FIG. 10 illustrates another preferred embodiment operation of the apparatus of FIG. 1, in flow diagram form. With reference to FIG. 10, the operation of the apparatus 100 commences at step 1000. At step 1001 a user, who can be either a principal or a prospective principal can access the central processing computer 10 via a user communication device 30. At step 1002, the principal or prospective principal can enter search criteria regarding a desired type or kind of agent, attorney, or representative, into the user communication device 30 and the user communication device 30 can transmit the search criteria or a search request to the central processing computer 10. At step 1003, the central processing computer 10 can receive and process the search request.

At step 1004, the central processing computer 10 can identify an agent, attorney, or representative, or any number of agents, attorneys, or representatives, and can generate a search results message which can contain information regarding any identified agent(s), attorney(s) or representative(s). The search results message can also contain any information, or a link or links to such information, for each identified agent, attorney, or representative. The information can be or can include, but is not limited to, any of the information described herein as being stored in the database 10H for, regarding, or relating to, the agent, attorney, or representative. At step 1005, the central processing computer 10 can transmit the search results message to the user communication device 30.

At step 1006, the principal or prospective principal can, via the user communication device 30, review the information in the search results message and/or any information regarding any identified agent, attorney, or representative, and decide whether or not to hire, engage, or retain the services of, an identified agent, attorney, or representative. Thereafter, the principal or prospective principal can contact the agent, attorney, or representative. At step 1006, the principal or prospective principal can also hire, engage, or retain the services of, the agent, attorney, or representative, via the user communication device 30 by transmitting an appropriate message to the central processing computer 10. The central processing computer 10 can process the information regarding the principal's or the prospective principal's hiring, engaging, or retaining the services of, the agent, attorney, or principal, and register the agent, attorney, or representative, as being the respective agent, attorney, or representative of the principal or prospective principal, so that that information is available via the central processing computer 10 to the World at large. Information regarding the agent's, attorney's, or representative's authorization to act on behalf of the principal in any number of situations and any other information can also be stored and provided by the central processing computer 10. Thereafter, the operation of the apparatus 100 will cease at step 1007.

In this regard, the apparatus 100 and method of the present invention can be utilized in order to allow any principal or prospective principal, or any client, customer, or other individual, to search for and/or hire an agent, attorney, or representative. In the same manner, the apparatus 100 and method of the present invention can be utilized to allow an agent, attorney, or representative, to promote or advertise himself, herself, or itself, so as become hire, engaged, or retained by principals, clients, or customers, or to otherwise engage in business or client development activities.

The apparatus 100 and method of the present invention can be utilized, for example, by a high school athlete or an aspiring actor, or any other individual, professional or otherwise in order to find and retain an agent. In a same manner, the apparatus 100 and method of the present invention can be utilized by any individual or entity to find, hire, engage, or retain, the services of an agent, attorney or representative.

In another preferred embodiment, the apparatus 100 and method of the present invention can be utilized in order to generate and transmit alert messages to principals or prospective principals when a new agent, attorney, or representative, who or which meets or might meet the search criteria set by the principal or prospective principal, registers with the apparatus 100 or the central processing computer 10.

In another preferred embodiment, the apparatus 100 and method of the present invention can be utilized in order to allow an agent, attorney, or representative, (hereinafter “agent”), to search for, identify, or locate, a principal, prospective principal, client or customer (hereinafter “principal” or “prospective principal”). In a preferred embodiment, a principal or individual desiring to hire an agent, can post information regarding himself, herself, or itself, which information can include, but is not limited to, any of the data or information described herein as being stored in the database 10H for, regarding, or relating to, the principal.

In a preferred embodiment, the agent can access the central processing computer 10 using a user communication device 30, can enter search criteria regarding a desired type or kind of principal or prospective principal, and can transmit a search request to the central processing computer 10. The central processing computer 10 can receive and process the search request. The central processing computer 10 can identify a principal or prospective principal or any number of principals or prospective principals, and can generate a search results message which can contain information regarding any identified principal(s) or prospective principal(s). The central processing computer 10 can then transmit the search results message to the user communication device 30.

The search results message can also contain any information, or a link or links to such information, for each identified principal or prospective principal. The information can be or can include, but is not limited to, any of the information described herein as being stored in the database 10H for, regarding, or relating to, the principal or prospective principal. The agent can review the information in the search results message and/or any information regarding any identified principal or prospective principal and decide whether or not to contact the principal or prospective principal in order to attempt to be hired by, engage by, or retained by the principal or prospective principal. The agent can thereafter contact the principal or prospective principal. The principal or the prospective principal can also hire, engage, or retain the services of, the agent via the central processing computer 10. If the principal or prospective principal hires, engages, or retains, the agent, then information regarding same can be registered by the central processing computer 10 so as to be available via the central processing computer 10 to the World at large. Information regarding the agent's authorization to act on behalf of the principal in any number of situations and any other information can also be stored and provided by the central processing computer 10.

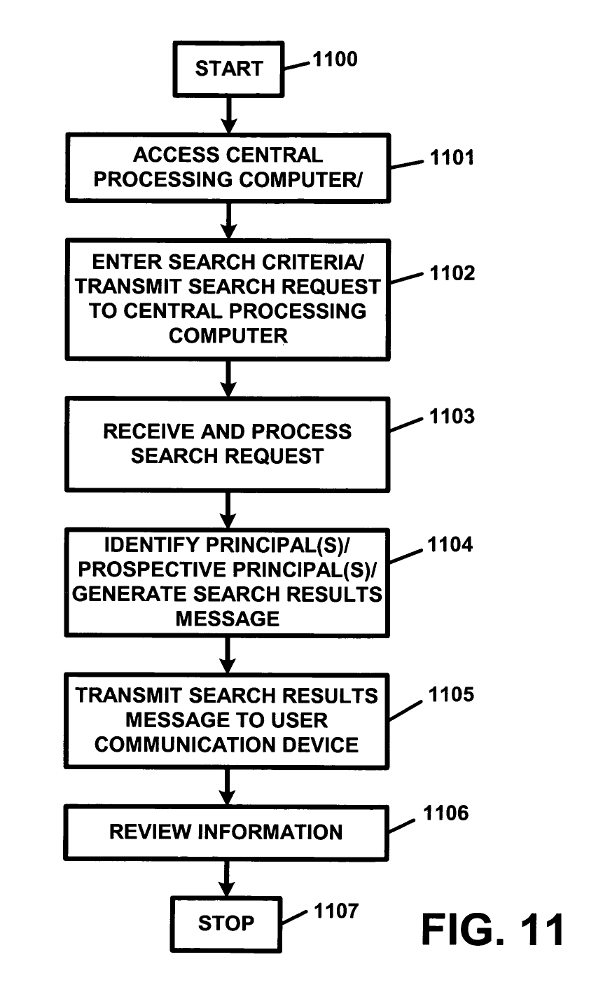

FIG. 11 illustrates another preferred embodiment operation of the apparatus of FIG. 1, in flow diagram form. With reference to FIG. 11, the operation of the apparatus 100 commences at step 1100. At step 1101 a user, who can be an agent can access the central processing computer 10 via a user communication device 30. At step 1102, the agent can enter search criteria regarding a desired principal or prospective principal into the user communication device 30 and the user communication device 30 can transmit the search criteria or a search request to the central processing computer 10. At step 1103, the central processing computer 10 can receive and process the search request.

At step, 1104, the central processing computer 10 can identify a principal or prospective principal, or any number of principals or prospective principals, and can generate a search results message which can contain information regarding any identified principal(s) or prospective principal(s). The search results message can also contain any information, or a link or links to such information, for each identified principal or prospective principal. The information can be or can include, but is not limited to, any of the information described herein as being stored in the database 10H for, regarding, or relating to, the principal or prospective principal which can be any individual, principal, client, or customer. At step 1105, the central processing computer 10 can transmit the search results message to the user communication device 30.

At step 1106, the agent can, via the user communication device 30, review the information in the search results message and/or any information regarding any identified principal or prospective principal and decide whether or not to contact the principal or prospective principal in an effort to be hire by, engaged by, or retained by, the principal or the prospective principal. Thereafter, the agent can contact the principal or prospective principal. At step 1106, the principal or prospective principal can also hire, engage, or retain the services of, the agent, attorney, or representative, via the user communication device 30 by transmitting an appropriate message to the central processing computer 10. The central processing computer can process the information regarding the principal's or the prospective principal's hiring, engaging, or retaining the services of, the agent, and register the agent as being the agent of the principal or prospective principal, so that that information is available via the central processing computer 10 to the World at large. Information regarding the agent's, attorney's, or representative's authorization to act on behalf of the principal in any number of situations and any other information can also be stored and provided by the central processing computer 10. Thereafter, the operation of the apparatus 100 will cease at step 1107.

In this regard, the apparatus 100 and method of the present invention can be utilized in order to allow any agent, attorney, or representative, to search for a principal or prospective principal. In the same manner, the apparatus 100 and method of the present invention can be utilized to allow an agent, attorney, or representative, to seek to become hired by, engaged by, or retained by, principals, clients, or customers, or to otherwise engage in business or client development activities.

The apparatus 100 and method of the present invention can be utilized, for example, by a sports or entertainment agent in order to find and secure clients. In a same manner, the apparatus 100 and method of the present invention can be utilized by any agent, attorney, or representative to find and be hired, engaged, or retained, by any principal, client, or customer.

In another preferred embodiment, the apparatus 100 and method of the present invention can be utilized in order to generate and transmit alert messages to agents, attorneys, or representatives, when a principal or prospective principal, who or which meets or might meet the search criteria set by the agent, attorney, or representative, registers with the apparatus 100 or the central processing computer 10.

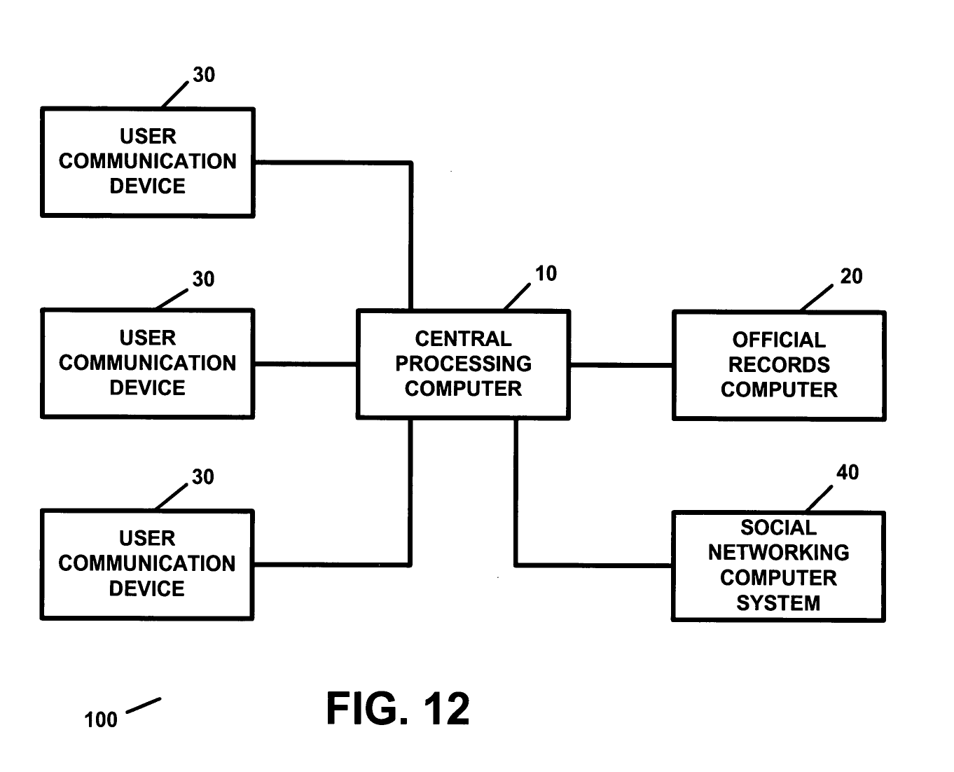

In another preferred embodiment, the apparatus 100 and method of the present invention can be utilized in connection with one or more social networking websites or social networking computer systems. FIG. 12 illustrates another preferred embodiment of the apparatus 100 of the present invention, in block diagram form. With reference to FIG. 12, the apparatus 100 includes a social networking computer system 40. In a preferred embodiment, the social networking computer system 40 can be, or can be linked to, any Facebook®, Twitter, or other social networking computer system or any other social networking computer systems.

The social networking computer system 40 can include all of the components and elements described herein as being included in a central processing computer 10 and can also store in its database any and/or all of the information described herein as being stored in the database 10H as well as any and/or all information which can be posted to or stored in or on a social networking computer system or in or on an individual's or an entity's social networking account or page, such as in an individual's or entity's Facebook®, Twitter, or other social networking website account or page. The information stored in the social networking computer system 40 can include, for each individual or entity, identification information, information regarding friends or followers of the individual or entity, or others, professional information, work samples, life history information, personalized statements, video recordings, audio recordings, videos of activities, events, or performances, and any other information which can be store or posted to any social networking website or social networking account for or on behalf of an individual or entity.

In another preferred embodiment of the present invention, and in particular, in another preferred embodiment of the embodiment described in connection with FIG. 10 described herein, the search results message described as being generated at step 1004, and transmitted to the user communication device 30 at step 1005, can contain, for each identified agent, attorney, or representative, a link or links to information found at the respective agent's, attorney's, or representative's, Facebook, Twitter, or other social networking account or page and/or any information stored or posted on or at same. In this regard, the respective principal or prospective principal can be linked to and access information posted or stored on the agent's, attorney's, or representative's, Facebook, Twitter, or other social networking account or page.

In another preferred embodiment of the present invention, and in particular, in another preferred embodiment of the embodiment described in connection with FIG. 11 described herein, the search results message described as being generated at step 1104, and transmitted to the user communication device 30 at step 1105, can contain, for each identified principal or prospective principal, a link or links to information found at the respective principal's or prospective principal's, Facebook, Twitter, or other social networking account or page and/or any information stored or posted on or at same. In this regard, the respective agent, attorney, or representative, can be linked to and access information posted or stored on the principal's or prospective principal's, Facebook, Twitter, or other social networking account or page.

The apparatus 100 can be used by any individual or entity, in any field of endeavor, in any walk of life, professional, amateur or otherwise, to promote themselves to agents, attorneys, or representatives, in the hopes of being able to secure the services of or representation by an agent, attorney, or representative in the field of their endeavor. In this manner, as and for an example, an athlete or an aspiring entertainer can post video clips of their performances on their social networking page along with statistics, performance measure, ratings, reviews, or other information, in an ongoing manner so that an agent or agents can monitor or follow them or their progress. In this manner, an agent may scout or follow prospective new clients while the individual or entity can market themselves to agents, attorneys, or representatives.

In another embodiment, in an analogous manner, the apparatus 100 can be used by any agent, attorney, or representative, in any field of endeavor, in any walk of life, professional, amateur or otherwise, to promote themselves to individuals and entities in the hopes of being hired, engaged, or retained, by an individual or entity. In this manner, as and for an example, a sports or entertainment agent can provide or post information regarding clients, reviews, past successful deals, contact and networking information, video clips, statistics, performance measures, ratings, reviews, or other information, in an ongoing manner so that an individual or entity can monitor or follow them or their progress. In this manner, an individual or agent can scout or follow an agent or his or her progress while the agent can market themselves to individuals and entities.

The apparatus 100 and method of the present invention can be utilized to store, and serve as a repository for, any and/or all of the information described herein as well as any and all negotiations and/or contracts or agreements which are entered into between any parties who utilize the apparatus 100 and method of the present invention. The apparatus 100 and method of the present invention can store any and all communications, correspondence, telephone call recordings, telephone call transcripts, video conferences, video conference transcripts, e-mails, text or SMS messages, or any other information, correspondence, or communications, which occur between and among principals and their agents, agents and third parties, and principals and third parties.

In another preferred embodiment, the apparatus 100 and method of the present invention can be utilized in order to store any and/or all agreements or contracts entered into by any of the parties who or which utilize the apparatus 100 and method of the present invention, whether these agreements or contracts are confidential or not. These agreements or contracts can also be stored and maintained confidentially and/or for any purpose, for evidentiary purposes, or for later retrieval and use by a party. These agreements or contracts can also be made available and provided to any other user of the apparatus 100 and method of the present invention if appropriate permission is obtained from the parties.

Blank forms or template agreements or contracts can also be stored and can be provided or can be sold to any other users of the apparatus 100 and method of the present invention. In this manner, the apparatus 100 and method of the present invention can be utilized as a repository for agreements and/or contracts between parties, for later use by the parties, and/or can be a source of blank or template agreements or contracts which the parties or other users of the apparatus 100 and method of the present invention can obtain and utilize in their dealings with others.

The apparatus 100 and method of the present invention can be utilized by agents, representatives, attorneys, or any other individuals, persons, or entities, who or which act on behalf of any principal, client, customer, or any other individual, person or entity. For example, the apparatus 100 and method of the present invention can, be utilized by agents, attorneys, or representatives, for legal clients, celebrities, actors, actresses, television personalities, athletes, sports professionals, amateur athletes, high school and college athletes, performers, or individuals or entities in any walk of life, or any other individual, person, or entity, that may have for a need for, or a desire to utilize or employ the services of, an agent, an attorney, a representative, or a personal representative, in any type or kind of field, industry, activity, action, or in any endeavor.

The apparatus 100 and method of the present invention can also be utilized to receive, store, and provide upon request, information regarding references, compliments, complimentary statements, positive reviews, negative reviews, or complaints, about or regarding any of the principals, agents, third parties, or any other individuals, persons, or entities, who or which utilize the apparatus 100 of the present invention or who or which engage in activities which involve use of the apparatus 100 and method of the present invention. In this regard, the apparatus 100 and method of the present invention can be utilized to perform research regarding any of the herein-described principals, agents, third parties, or any other individuals, persons, or entities. In this regard, the apparatus 100 and method of the present invention can be utilized in order to process requests for, and to generate and transmit or otherwise provide messages regarding, any information regarding references, compliments, complimentary statements, positive reviews, negative reviews, or complaints, about or regarding any of the herein-described agents, third parties, or any other individuals, persons, or entities.

The apparatus 100 and method of the present invention can be utilized in connection with any relationship involving an agent, an attorney, or a representative, for any principal, individual, or entity. In another preferred embodiment, an employee, an independent contractor, a proxy holder, a healthcare proxy holder, an administrator, an administratrix, one who have been given letters of administration, an executor, an executrix, a guardian, or any other individual or entity who owes a duty to another or to an entity, and each of the foregoing can also be included within the definition of agent, attorney, or representative.

The apparatus 100 and method of the present invention can also be utilized as a repository for all engagement agreements, employment agreements, independent contractor agreements, retainer agreements, powers of attorney, letters of administration, letters of authorization, proxies, or and any other documents or things that can evidence a principal/agent relationship. In this regard, any engagement agreement, employment agreement, independent contractor agreement, retainer agreement, power of attorney, letter of administration, letter of authorization, proxy, or and any other document or thing that can evidence a principal/agent relationship can be stored in the central processing computer 10 and can be access and retrieved by any authorized individual at any time.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. A computer-implemented method, comprising:
receiving, with a receiver or a computer, a search request for information regarding an agent;
processing, with the computer or with a second computer, the search request;
generating, with the computer or with a second computer, a message in response to the search request, wherein the message contains information identifying at least one agent in response to the search request; and
transmitting, from a transmitter, the first computer, or the second computer, the message to a communication device used by or associated with a user.

2. The computer-implemented method of claim 1, further comprising:
processing and storing information regarding a hiring, an engagement, or a retention, of the agent by the user or by a principal.

3. The computer-implemented method of claim 1, further comprising:
receiving a request for information regarding a principal in a principal/agent relationship;
processing, with the computer or with the second computer, the request for information;
generating, with the computer or with the second computer, a second message in response to the request for information, wherein the second message contains contact information for an agent of the principal, wherein the contact information contains an e-mail, an instant message or text message number, a telephone number, or a cellular, mobile, or wireless telephone number, of or for the agent; and
transmitting, from the transmitter, the first computer, or the second computer, the second message to the communication device or to a second communication device used by or associated with the user or a second user.

4. The computer-implemented method of claim 3, further comprising:
storing information regarding the user or the second user.

5. The computer-implemented method of claim 3, further comprising:
processing a request for information regarding the principal;
generating a third message containing information regarding the principal, and
transmitting the third message to the user communication device or to the second user communication device.

6. The computer-implemented method of claim 3, further comprising:
receiving and storing a reply from the communication device or from the second communication device, wherein the reply contains information regarding a desire by the user to contact the agent for the principal in order to conduct business, negotiate a contract, negotiate an agreement, enter into an agreement or a contract, negotiate a settlement in a case where a dispute or a lawsuit exists or is pending between the principal and a party represented by the user, compromise a dispute or lawsuit, settle a dispute or lawsuit, or otherwise reach an agreement, accord, or settlement, or to put an end to a dispute or a pending lawsuit between the principal and a party represented by the user.

7. The computer-implemented method of claim 3, further comprising:
generating a notification message or an alert message containing information regarding an intention by the user to contact the agent of the principal.

8. The computer-implemented method of claim 7, further comprising:
transmitting the notification message or the alert message to a third communication device, wherein the third communication device is used by or associated with the principal or the agent.

9. The computer-implemented method of claim 1, wherein the communication device is a cellular telephone or a personal digital assistant.

10. The computer-implemented method of claim 1, wherein the communication device is an interactive television.

11. A computer-implemented method, comprising:
receiving, with a receiver or a computer, a search request for a principal or a prospective principal;
processing, with the computer or with a second computer, the search request;
generating, with the computer or with a second computer, a message in response to the search request, wherein the message contains information identifying at least one principal or prospective principal in response to the search request; and
transmitting, from a transmitter, the first computer, or the second computer, the message to a communication device used by or associated with a user.

12. The computer-implemented method of claim 11, further comprising:
processing and storing information regarding a hiring, an engagement, or a retention, of the agent by a principal or a prospective principal.

13. The computer-implemented method of claim 11, further comprising:
receiving a request for information regarding a principal in a principal/agent relationship;
processing, with the computer or with the second computer, the request for information;
generating, with the computer or with the second computer, a second message in response to the request for information, wherein the second message contains contact information for an agent of the principal, wherein the contact information contains an e-mail, an instant message or text message number, a telephone number, or a cellular, mobile, or wireless telephone number, of or for the agent; and
transmitting, from the transmitter, the first computer, or the second computer, the second message to the communication device or to a second communication device used by or associated with the user or a second user.

14. The computer-implemented method of claim 13, further comprising:
storing information regarding the user or the second user.

15. The computer-implemented method of claim 11, further comprising:
processing a request for information regarding the principal;
generating a third message containing information regarding the principal, and
transmitting the third message to the user communication device or to the second user communication device.

16. The computer-implemented method of claim 11, further comprising:
receiving and storing a reply from the communication device or from the second communication device, wherein the reply contains information regarding a desire by the user to contact the agent for the principal in order to conduct business, negotiate a contract, negotiate an agreement, enter into an agreement or a contract, negotiate a settlement in a case where a dispute or a lawsuit exists or is pending between the principal and a party represented by the user, compromise a dispute or lawsuit, settle a dispute or lawsuit, or otherwise reach an agreement, accord, or settlement, or to put an end to a dispute or a pending lawsuit between the principal and a party represented by the user.

17. The computer-implemented method of claim 11, further comprising:
generating a notification message or an alert message containing information regarding an intention by the user to contact the agent of the principal.

18. The computer-implemented method of claim 17, further comprising:
transmitting the notification message or the alert message to a third communication device, wherein the third communication device is used by or associated with the principal or the agent.

19. The computer-implemented method of claim 11, wherein the communication device is a cellular telephone or a personal digital assistant.

20. The computer-implemented method of claim 11, wherein the communication device is an interactive television.
